(19) United States
(12) Patent Application Publication
(10) Pub. No.: US 2007/0086067 A1
(43) Pub. Date: Apr. 19, 2007

(54) Imaging apparatus having output circuits selectably operative dependant upon usage and a method therefor

(75) Inventors: Kazunori Suemoto, Asaka-shi (JP); Katsumi Ikeda, Kurokawa-gun (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/546,397

(22) Filed: Oct. 12, 2006

(30) Foreign Application Priority Data
Oct. 13, 2005 (JP) 2005-299297
Oct. 13, 2005 (JP) 2005-299298
Oct. 13, 2005 (JP) 2005-299306

(51) Int. Cl. H04N 1/04

(52) U.S. Cl. 358/482; 358/474

(57) ABSTRACT

An image pickup apparatus includes a plurality of output channels and appropriately operates depending on use situation. The image pickup apparatus includes a system control for determining whether a condition is set on a resolution representing a first speed mode, a resolution representing a second speed mode faster than VGA (Video Graphics Array), or an HDTV (High Definition TeleVision) to generate a control signal depending on the determination result. The control signal controls a drive mode control. Under the control of a timing signal generator responsive to a control signal supplied from the drive mode control, an image sensor and a driver therefor provides image signals captured on two outputs or a single output. The drive mode control controls processing of the image signals in a preprocessor so as to correspond to the number of the output channels of the image sensor.

### BACKGROUND OF THE INVENTION

1. Field of the Invention

The present invention relates to an image pickup apparatus, and more specifically to an image pickup apparatus that uses an image sensor having a plurality of output stages to enable signal charges to be read out at a high transfer rate.

2. Description of the Background Art

To achieve an image sensor enabling signal charges to be read out at a high transfer rate, an image sensor or an image pickup apparatus having a plurality of outputs or horizontal transfer paths is proposed in Japanese patent laid-open publication Nos. 2004-194023 and 103421/1999. The former, '023 publication, discloses an image pickup apparatus in which signal charges are read out only from a selected portion of its photosensitive array and are then transferred to be developed from two output amplifiers in the form of analog signals. The latter, '421 publication, discloses a solid-state image sensor and a driving method thereof in which the photosensitive array is not divided in the horizontal direction but in the vertical direction into the upper and lower areas, which have respective horizontal transfer paths in the upper and lower ends through which the image signals are read out.

Another Japanese patent laid-open publication No. 298626/1996, discloses a solid-state image sensor that has one end of its horizontal transfer path branched into two, one of whose output stage is selected depending on the sensitivity for photographing.

The above-identified '023 and '421 publications provides a plurality of output stages so that signal charge reading is advantageously achieved at a high rate. To do so, however, power saving and signal corrections by means of a variety of processings are required due to the divided photosensitive array. The image sensor taught by the above-identified '626 publication is excellent in that the sensitivity of photographing is selectable depending upon the shooting environment to provide an image signal for the appropriate image quality, but is inferior in signal charge reading.

### SUMMARY OF THE INVENTION

It is an object of the present invention to provide an image pickup apparatus that includes a plurality of output circuits and may appropriately operate depending on use situation, and an image processing method therefor.

The present invention provides an image pickup apparatus comprising: an image sensor for receiving incident light from an subject field and producing signal charges corresponding to the incident light, the image sensor including a plurality of output circuits for converting the signal charges to an image signal to output the image signal, the image sensor being driven depending on operational situation; a controller for generating a control signal to control operation of the image sensor depending on a multiple-output mode or a single-output mode; a timing generator operative in response to the control signal for generating a timing signal for the image sensor; a drive signal generator operative in response to the timing signal for generating a drive signal; a preprocessor for applying at least noise reduction and digitization on the image signal on an output channel corresponding to effective one of the plurality of output circuits; and a processing controller operative in response to the control signal for controlling a processing for each of the output channels of the preprocessor, the controller determining whether the multiple-output mode is a second speed mode faster than a first speed mode, and generating the control signal depending on a result of determination, the processing controller controlling the processing for a one-output channel in the first speed mode, and controlling the processing for a multiple-output channel in the second speed mode.

The image pickup apparatus of the present invention, determines, in a controller, a condition is a second speed mode faster than a first speed mode determination, generates a control signal depending on the determination result, controls, in response to the control signal, a timing generator, a drive signal generator, and a processing controller, images by an imaging subsection driven by the drive signal generator, provides the obtained image signal in a plurality of the outputs in the second speed mode, reads out a normal image signal in the first speed mode, and controls, by the processing controller, a preprocessor to which the image signal is supplied correspondingly to the number of the outputs of the imaging subsection, thereby making it possible to appropriately operate depending on use situation. The useless operation may thus be avoided.

The present invention also provides an imaging processing method for producing an image signal from signal charges obtained via photoelectric conversion from incident light from a subject field, and providing the image signals on multiple outputs driven depending on operational situation, the method comprising: a first step of acquiring a preset condition; a second step of determining whether the acquired set condition includes a first speed mode or a second speed mode that is faster than the first speed mode, and producing a control signal depending on a result of determination; a third step of setting generation of a timing signal for providing the image signals in multiple outputs in response to the result of determination including the second speed mode; a fourth step of setting generation of a normal timing signal for outputting the image signal on one channel in response to the result of determination including the first speed mode; a fifth step of setting at least noise reduction and digitization on the image signals on a plurality of output channels supplied according to the result of determination including the second speed mode; a sixth step of setting at least noise reduction and digitization on the image signal on one output channel supplied according to the result of determination including the first speed mode; a seventh step of rearranging image data on the plurality of output channels digitized and supplied according to the result of determination including the second speed mode into a sequence of pixels in a normal dot-sequential manner; and an eighth step of setting output of the image data on one output channel digitized and supplied according to the result of determination including the first speed mode, whereby imaging is performed according to the settings to obtain the image data through the preprocessings.

The imaging processing method of the present invention, acquires a set condition, determines whether the condition includes a first speed mode or a second speed mode faster than the first speed mode, produces a control signal depending on the determination result, sets generation of a timing signal to provide an image signal in multiple outputs according to the determination result including the second speed mode, sets at least noise reduction and digitization on the supplied image signal on a plurality of output channels, rearranges the supplied image signal on the plurality of output channels into a sequence of pixels in a normal dot-sequential manner, sets generation of a normal timing signal to provide the image signal in a single output according to the determination result including the first speed mode, sets at least noise reduction and digitization on the supplied image signal on the single output channel, and sets the output of the supplied image signal on the single output channel, thereby making it possible to appropriately operate for each mode the processing depending on the output for imaging, and avoid useless operation.

Further in accordance with the present invention, an image pickup apparatus comprises: an image sensor for receiving incident light from an subject field and producing signal charges corresponding to the incident light, the image sensor including a plurality of output circuits for converting the signal charges to an image signal to output the image signal, the image sensor being driven depending on situation of operation; an operation panel for instructing the operation; a controller operative in response to at least one of an operation signal from the operation panel and a predetermined condition for producing a control signal to control the operation of the image sensor; a timing generator operative in response to the control signal for generating a timing signal for the image sensor; a drive signal generator operative in response to the timing signal for generating a drive signal; a preprocessor for applying at least noise reduction and digitization on the image signal on an output channel corresponding to effective one of the plurality of output circuits; and a power controller operative in response to the control signal for controlling power supply, with respect to at least one of the output channels, to the preprocessor and the plurality of output circuits of the image sensor.

Still further in accordance with the invention, an image pickup apparatus comprises: an image sensor for receiving incident light from an subject field and producing signal charges corresponding to the incident light, the image sensor including a plurality of output circuits for converting the signal charges to an image signal to output the image signal, the image sensor being driven depending on situation of operation; an operation panel for instructing the operation to produce an operation signal; a controller operative in response to the operation signal for producing a control signal to control a recording operation mode and a non-recording operation mode of the apparatus; a timing generator operative in response to the control signal for generating a timing signal for the image sensor; a drive signal generator operative in response to the timing signal for generating a drive signal; a preprocessor for applying at least noise reduction and digitization on the image signal on an output channel corresponding to effective one of the plurality of output circuits; and a processing controller operative in response to the control signal for controlling a processing for each of the output channels of the preprocessor, the controller being operative in response to a set condition and a condition included in the operation signal to determine whether to be in the recording operation mode or the non-recording operation mode to produce the control signal according to a result of determination, the processing controller controlling, in the recording operation mode, the processing at least on one output channel, and controlling, in the non-recording operation mode, the processing in a plurality of output channels.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a configuration of a digital camera to which applied is an image pickup apparatus according to the present invention;

FIG. 2 is a schematic plan view showing the configuration of the image sensor used in the imaging subsection shown in FIG. 1;

FIG. 3 is a plan view schematically showing an electrode configuration in the vicinity of the boundary between two horizontal transfer paths including a line memory in the image sensor shown in FIG. 2;

FIG. 4 is a cross sectional view taken along the cutting line IV-IV in the image sensor in FIG. 3;

FIG. 5 illustrates how the two horizontal transfer paths in the image sensor shown in FIG. 2 transfer signal charges to the left and right;

FIG. 6 illustrates how the two horizontal transfer paths in the image sensor shown in FIG. 2 transfer signal charges in one direction;

FIG. 7 is a schematic plan view of an alternative electrode configuration in the vicinity of the boundary between two horizontal transfer paths including the line memory in the image sensor shown in FIG. 2;

FIG. 8 is a cross sectional view taken along the cutting line VIII-VIII in the image sensor in FIG. 7;

FIG. 9 illustrates how the two horizontal transfer paths in the image sensor shown in FIG. 7 transfer signal charges in left and right directions;

FIG. 10 illustrates how the two horizontal transfer paths in the image sensor shown in FIG. 7 transfer signal charges in one direction;

FIG. 11 is a functional block diagram showing the general function of the system control shown in FIG. 1;

FIG. 12 is a functional block diagram showing the control functional blocks included in the setting/operation-responsive control functional block shown in FIG. 11;

FIG. 13 schematically illustrates the configuration of the control panel shown in FIG. 1;

FIG. 14 is a flowchart of the operational procedure depending on the resolution of the digital camera shown in FIG. 1;

FIG. 15 is a flowchart of the operational procedure depending on the frame rate of the digital camera shown in FIG. 1;

FIG. 16 is a flowchart of the operational procedure depending on the continuous-shooting speed of the digital camera shown in FIG. 1;

FIG. 17 is a schematic block diagram showing an alternative configuration of a digital camera to which applied is an image pickup apparatus according to the present invention;

FIG. 18 is a flowchart of the operational procedure depending on the number of outputs of the imaging subsection of the digital camera shown in FIG. 17;

FIG. 19 is a schematic block diagram showing another alternative configuration of a digital camera to which applied is an image pickup apparatus according to the present invention;

FIG. 20 is a flowchart of the procedure for setting and operating the drive voltage depending on the number of the outputs of the imaging subsection of the digital camera shown in FIG. 17;

FIG. 21 is a schematic block diagram showing still another alternative configuration of a digital camera to which applied is an image pickup apparatus according to the invention;

FIG. 22 is a flowchart of the procedure for setting and enabling the clock signal and power supply to be turned on and off depending on the number of the outputs of the imaging subsection of the digital camera shown in FIG. 21;

FIG. 23 is a schematic block diagram showing a further alternative configuration of a digital camera to which applied is an image pickup apparatus according to the invention;

FIGS. 24, 25 and 26 are flowcharts of the operational procedure for turning on and off the power supply depending on the battery capacity of the digital camera shown in FIG. 23;

FIG. 27 is a schematic block diagram showing a still another alternative configuration of a digital camera to which applied is an image pickup apparatus according to the invention;

FIG. 28 is a flowchart of the operational procedure for turning on and off the power supply depending on a portion to be supplied with the power and battery capacity of the digital camera shown in FIG. 23;

FIG. 29 is a flowchart of the operational procedure depending on whether or not recording is possible in the digital camera shown in FIG. 1; and

FIGS. 30 and 31 are timing charts illustrating the number of the outputs and the operation of the digital camera shown in FIG. 1 in response to the depression of its shutter release button.

### DESCRIPTION OF THE PREFERRED EMBODIMENTS

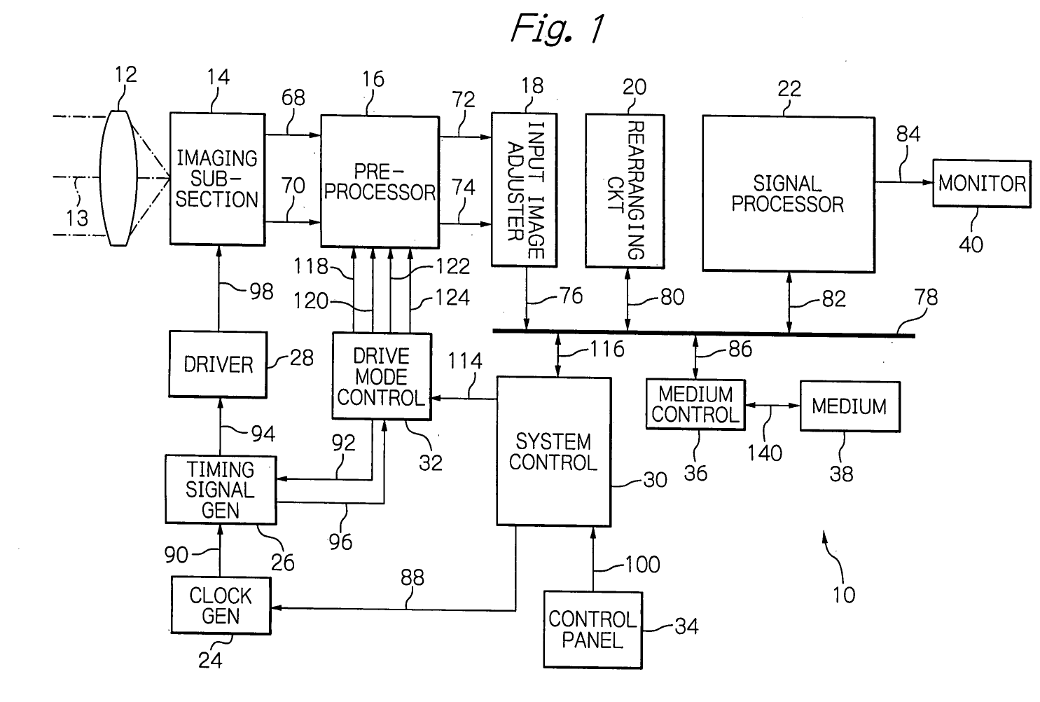

With reference to the accompanying drawings, preferred embodiments of the image pickup apparatus of the present invention will be described in more detail. The instant embodiment is directed to an image pickup apparatus applied to a digital camera 10, FIG. 1. Illustration and description of portions not directly relevant to understanding the present invention will be omitted.

Referring to FIG. 1, the digital camera 10 includes an optical system 12, an imaging subsection 14, a preprocessor 16, an input image adjuster 18, a rearranging circuit 20, a signal processor 22, a clock generator 24, a timing signal generator 26, a driver 28, a system control 30, a drive mode control 32, a control panel 34, a medium control 36, a recording medium 38, and a display monitor 40, which are interconnected as illustrated.

The optical system 12 has a function of conducting incident light 13 from a subject field into the imaging subsection 14 in response to the operation on the control panel 34. The optical system 12 adjusts the angle of field or focal distance in response to the zoom operation or half-stroke operation of a shutter release button, not shown, on the control panel 34.

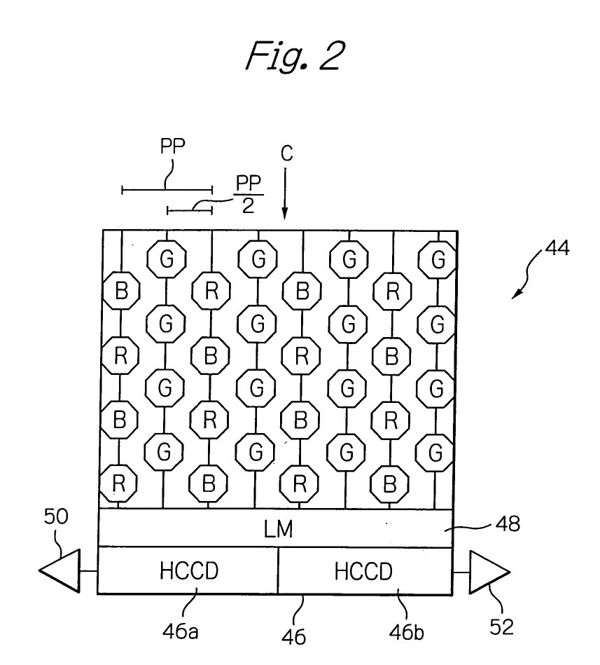

The imaging subsection 14 includes an image sensor 44, FIG. 2, which has an array of photosensitive cells or devices, and color filter segments 45 disposed in the direction in which the incident light 13 comes in registration with the positions where the photosensitive devices are located. The color filter segments 45 separate the incident light 13 into color components. The image sensor 44 has a function of converting the color components thus separated into corresponding electric signal charges by the photosensitive devices, and outputting the electrical signals.

Referring now to FIG. 2, the color filter segments 45 of the image sensor 44 of this embodiment are of the three primary colors R, G, and B arranged in such a way that the pixels in adjacent rows in the same horizontal direction are shifted from each other by a distance equal to the half of the pixel pitch PP. In the color filter segments 45, the segments of color G are arranged in a lattice pattern, and the segments of colors R and B are arranged in a complete checkered pattern. The imaging subsection 14 in FIG. 2 includes a vertical transfer path, not shown. The imaging subsection 14 is adapted to read out the signal charges stored in response to an exposure operation into the vertical transfer path, which transfers the signal charges sequentially in the vertical direction. The image sensor 44 has a line memory 48 formed between the vertical transfer path and a horizontal transfer path 46. The vertically transferred signal charges are supplied via the line memory 48 to the horizontal transfer path 46, which comprises sections 46a and 46b.

The horizontal transfer path 46 is comprised of the horizontal transfer paths 46a and 46b as its left and right halves partitioned by a central line C, which nearly bisects the columns of the photosensitive devices forming the imaging array of cells into two portions. From the horizontal transfer path 46 (46a, 46b), depending on the drive mode described below, both or either of output amplifiers 50 and 52 conduct analog electrical signals to output.

The image sensor 44 will further be described below. The image sensor 44 includes the vertical transfer paths (VCCD), not shown, formed so as to bypass the photosensitive devices, and the line memory (LM) 48. Because they have the same configurations as the conventional ones, their description will be omitted here. The vertical transfer paths are driven with four-phase drive signals φV1 to φV4. In the following, signals are designated with reference numerals of connections on which they are conveyed.

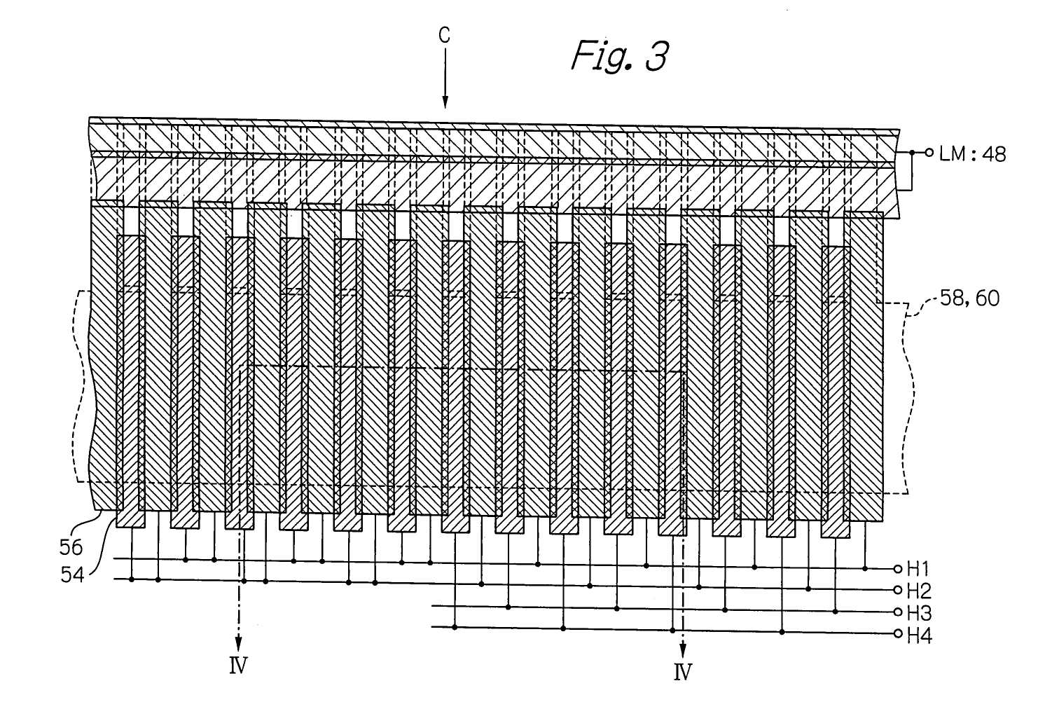

Consider now the horizontal transfer path 46 (46a, 46b), which is the characteristic of this embodiment. The horizontal transfer path 46 (46a, 46b) is arranged in the form as shown in FIG. 3. To the horizontal transfer path 46, applied is four-phase drive signals φH1 to φH4. This embodiment has the following characteristics. The horizontal transfer path 46a electrically connects electrodes 54 and 56 to form one group of electrodes so that the electrodes “H2 and H1” are repetitively arranged from the central portion C toward its left end portion. The horizontal transfer path 46b located in the right of the central portion C electrically independently wires the electrodes 54 and 56 so that the electrodes “H4, H2, H3, and H1” are repetitively arranged from the central portion C toward the right end portion.

As described above, the electrodes 54 and 56 connected into one group so that the groups are the same in number as the vertical transfer paths. This is because the line memory 48 intervenes between the vertical transfer paths and horizontal transfer path 46. The line memory 48 allows only the signal charges of the columns connected to the line memory 48 to be read into the horizontal transfer path 46 for temporary storage.

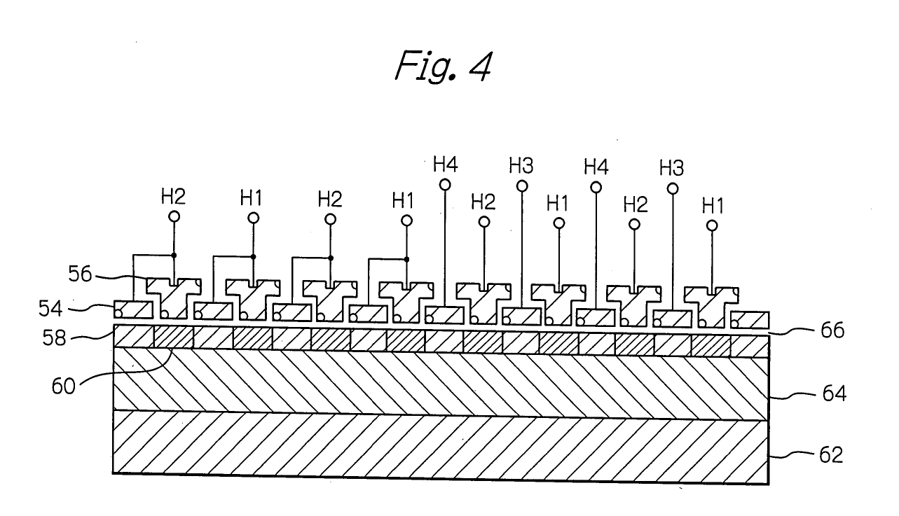

The image sensor 44 is the same as those disclosed in the conventional technologies except the electrode arrangement or alignment of the horizontal transfer path 46 and the timing of the driving waveforms as will be described below. The disclosure is shown in FIG. 4, where one conductivity type semiconductor substrate 62 has on its surface a well layer 64 having a conductivity type opposite to that of the substrate. The formed well layer 64 has on its surface impurity layers 58 and 60 having a conductivity type opposite to that of the well layer 64 to form transfer channels. The impurity layers 58 and 60 correspond to the transfer channels. Comparing impurity layers 58 and 60 with each other, the impurity layer 60 forms a thinner impurity layer. Formed over the substrate 62 is a first electrode 54 via an insulating layer 66, and formed over the electrode 54 and substrate 62 is a second electrode 56 via the insulating layer 66. Formed under the electrode 54 is the impurity layer 58, and formed under the electrode 56 is the impurity layer 60. Each electrode has, however, a different pitch.

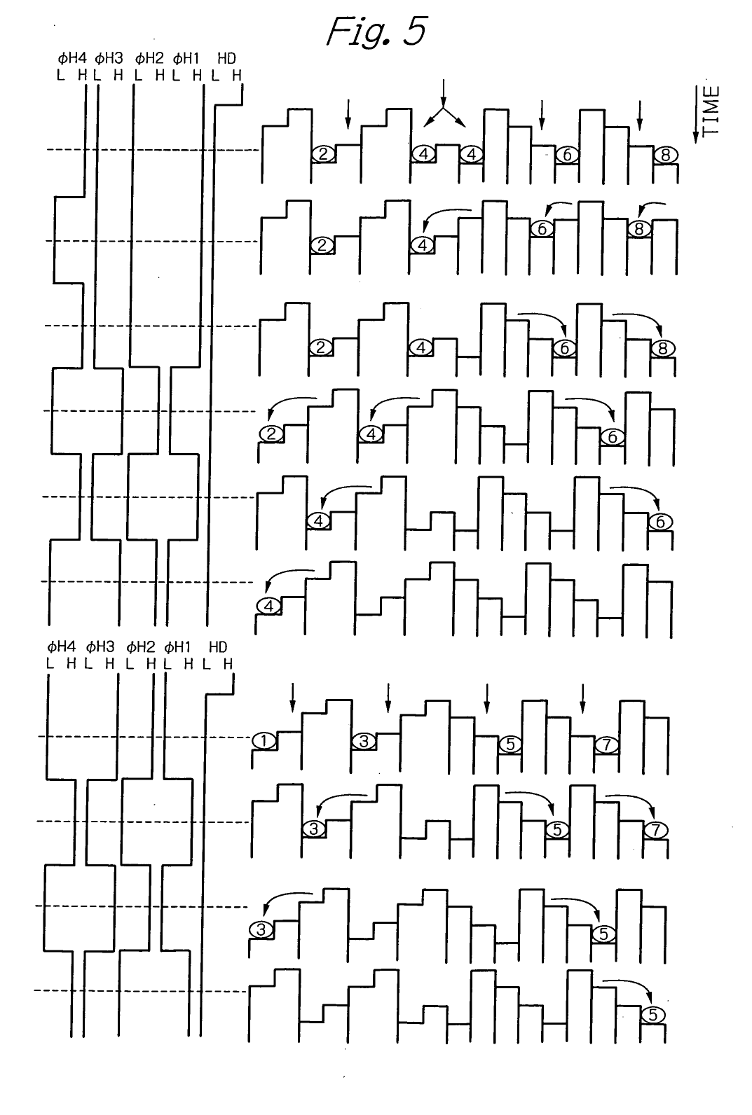

FIG. 5 illustrates how to drive to transfer the obtained signal charges to the left and right directions. FIG. 5 shows in the left portion the timing of the horizontal drive signals φH1 to φH4 for transferring the signal charges and the horizontal synchronous signals. Also shown in the right portion is the potential in the impurity layers 58 and 60 corresponding to the timing. Note that time elapses from top to bottom in the figure.

The signal charges transferred from the vertical transfer path are temporarily stored in the impurity layers 58 under the electrodes 56. The signal charges located around the central portion C are initially stored immediately under the electrodes H1 and H4 separately.

The drive signal φH4 is then applied at its low voltage to the electrode H4, thereby transferring the signal charges immediately under the electrode H4 to the portion under the electrode H1. One group of drive signals φH1 and φH4 is then applied along with a group of opposite-phase drive signals φH2 and φH3, thereby sequentially transferring the signal charges #4, #2, #3, and #1 in the horizontal transfer path 46a to the left, and signal charges #6, #8, #5, and #7 in the horizontal transfer path 46b to the right, respectively. Those signal charges #1 through #8 are indicated with circles in the figures.

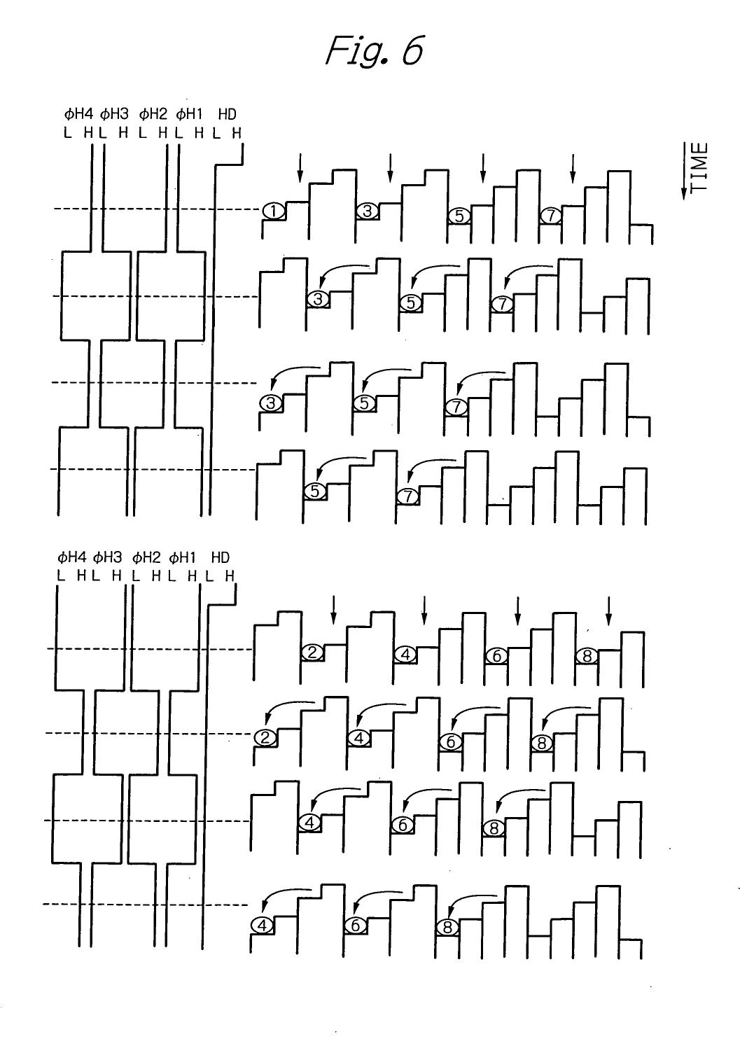

Well, referring to FIG. 6, the signal charges transferred to the horizontal transfer path 46 are sent to the left, i.e. in one direction, for example. FIG. 6 shows in the left portion the timing of the drive signal for achieving the signal charge transfer. FIG. 6 also shows in the right portion the potential in the impurity layers 58 and 60 corresponding to the timing. Note that time elapses from top to bottom in the figure.

The signal charges transferred from the vertical transfer path are temporarily stored, via the impurity layer 60 under the electrode 56, in the impurity layer 58 under the electrode 54. A group of drive signals φH1 and φH3 is applied along with a group of opposite-phase drive signals φH2 and φH4. This transfers all of the signal charges in the horizontal transfer paths 46a and 46b to the left.

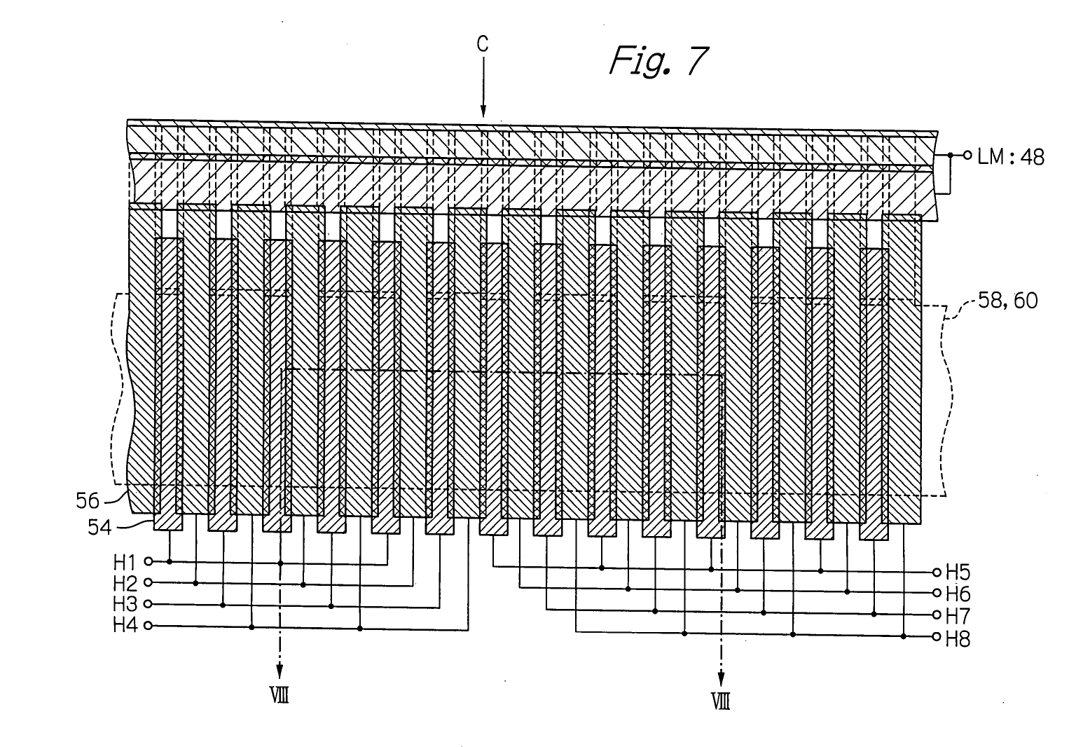

The image sensor 44 is not limited to the specific configuration of this embodiment, but may have, as shown in FIG. 7, the electrodes in the horizontal transfer path 46 (46a, 46b) divided into two halves to which the drive signals of eight phases φH1 to φH8 are applied. The horizontal transfer path 46 shown in FIG. 7 has the same configuration as in the image sensor 44 shown in FIG. 3 except the above-described electrode configuration.

These electrodes are the same as those shown in FIG. 3 in that the columns of the photosensitive devices may be nearly bisected so as to provide the horizontal transfer paths 46a and 46b as the left and right with respect to the central line C. The left horizontal transfer path 46a has the electrodes 54 and 56 wired electrically independently, and has the electrodes “H4, H3, H2, and H1” arranged repeatedly from the central portion C toward the left end portion. The right horizontal transfer path 46b also has the electrodes 54 and 56 wired electrically independently, and has the electrode “H5, H6, H7, and H8” arranged repeatedly from the central line C toward the right end portion.

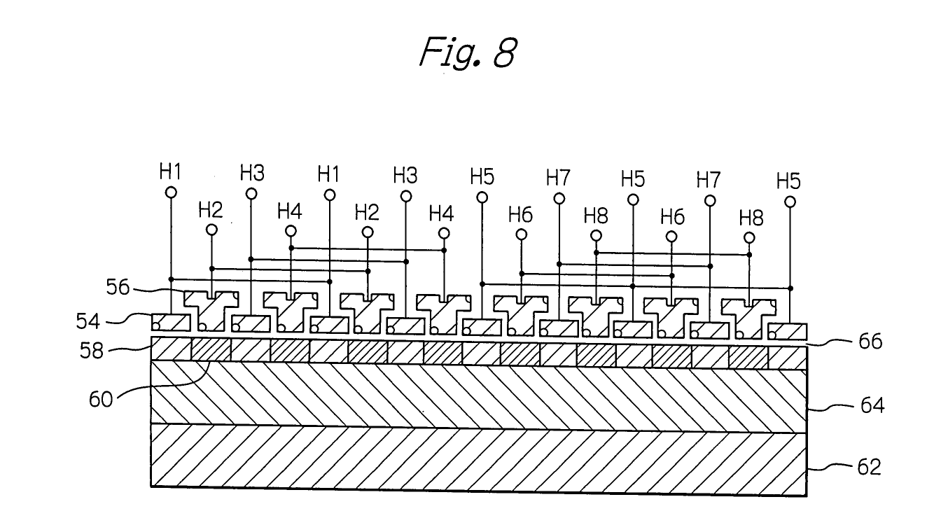

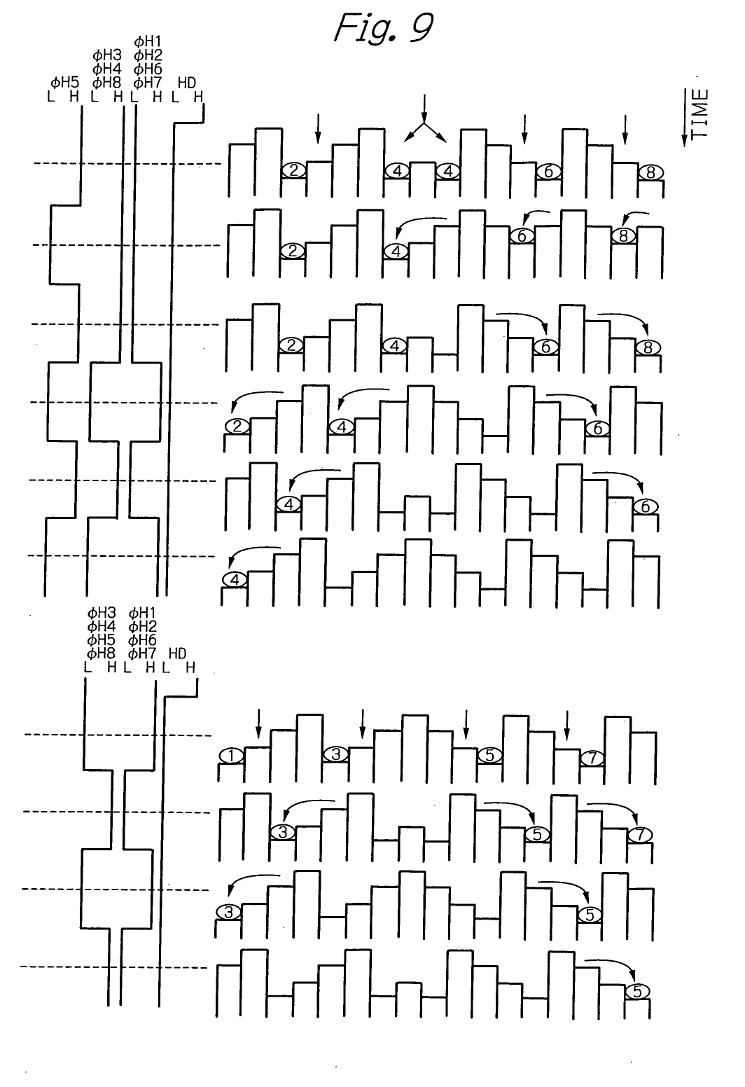

It is apparent that the cross-sectional view in FIG. 8 taken along the cutting line VIII-VIII in FIG. 7 is different from that in FIG. 4 only in the electrode configuration. FIG. 9 shows in the left portion the timing of the drive signals φH1 to φH8 when, in this electrode configuration, the signal charges transferred to the horizontal transfer path 46 are sent to the left and right from the central portion C. FIG. 9 also shows in the right portion the potential in the impurity layers 58 and 60 shown in FIG. 8 formed at this timing. Note that time elapses from top to bottom in the figure.

The signal charges transferred from the vertical transfer path to the horizontal transfer path 46 are temporarily stored, via the impurity layer 60 under the electrode 56, in the impurity layer 58 under the electrode 54. Particularly, the signal charges located around the central portion C are initially stored under the electrodes H3 and H5 separately. The low voltage (L level) drive signal φH5 may be applied to move the signal charges under the electrode H5 to the portion under the electrode H3. Then, a group of drive signals φH1, φH2, φH6, and φH7, and a group of opposite-phase drive signals φH3, φH4, φH5, and φH8 are applied to the electrodes to transfer the signal charges in the horizontal transfer path 46a to the left in FIG. 8 and the signal charges in the horizontal transfer path 46b to the right in FIG. 8.

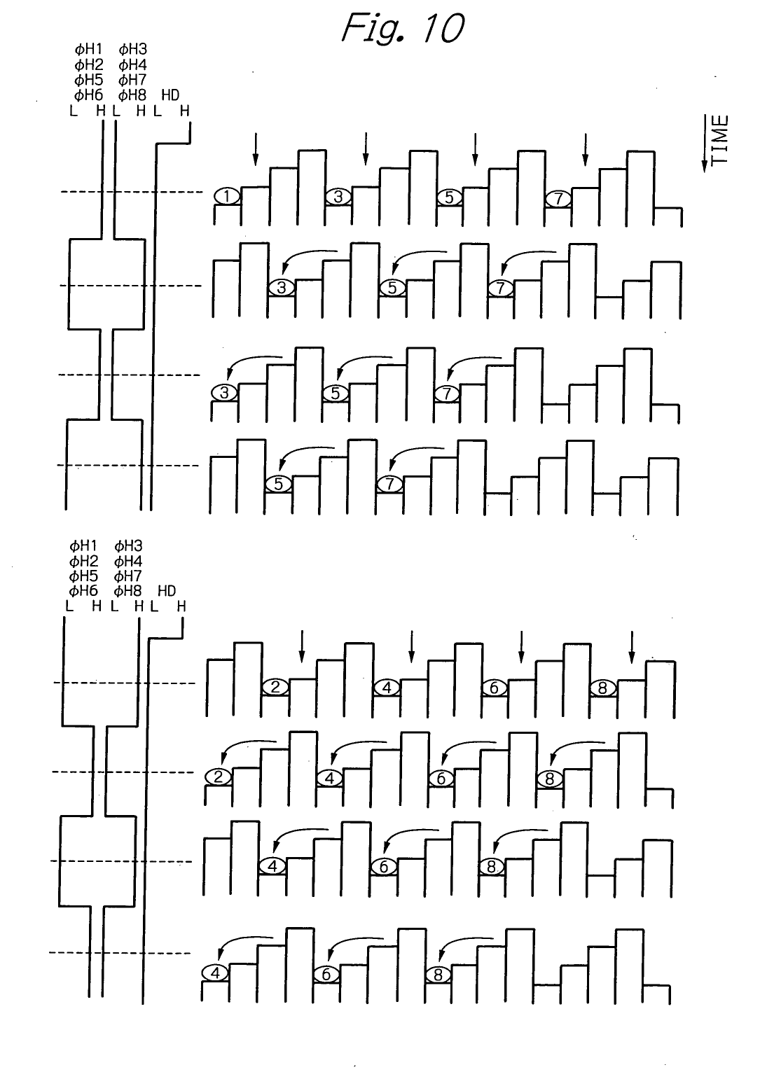

FIG. 10 illustrates the drive timing and potential for the above-described electrode configuration to transfer the signal charges in one direction. The signal charges are transferred here to the left in FIG. 10. Note that time elapses from top to bottom in the figure. The signal charges transferred from the vertical transfer path via the line memory 48 to the horizontal transfer path 46 are temporarily stored, via the impurity layer 60 under the electrode 56, in the impurity layer 58 under the electrode 54. One group of drive signals φH1, φH2, φH5, and φH6, and one group of opposite-phase drive signals φH3, φH4, φH7, and φH8 are applied to transfer the signal charges to the left throughout the horizontal transfer paths 46a and 46b.

Although not shown, one group of drive signals φH2, φH3, φH6, and φH7, and one group of opposite-phase drive signals φH1, φH4, φH5, and φH8 may be applied to transfer the signal charges to the right over the horizontal transfer paths 46a and 46b. The transfer to the right may cause a mirror image to be produced. Such a mirror image may be used, for example, for an image viewed on an on-vehicle rear-view mirror and the like.

In this way, the electrode wiring and its drive timing may be modified to select any one of the two channels of transfer direction. Depending on the user's request, the signal charges may thus be transferred in both directions or in a single direction. With the horizontal transfer only in one direction, the imaging subsection 14 is adapted to develop only the output OS1 (Output Signal 1).

Although the image sensor 44 has the four-phase and eight-phase drive signals applied in this embodiment, it may be adapted to have a six-phase drive signal applied. A timing chart may illustrate the number of the outputs depending on the operation of the shutter release button of the digital camera 10 shown in FIG. 1 and the operation of the digital camera. It is understood that the image sensor 44 is not limited to the type of image sensor having pixels shifted as shown in FIG. 2, but is also effective for a type of image sensor having pixels not shifted in which the photosensitive devices are arrayed in a lattice pattern.

Referring back to FIG. 1, the imaging subsection 14 outputs, from the image sensor 44, two-channel analog electrical signals 68 and 70 to the preprocessor 16.

The preprocessor 16 has an analog front end (AFE) function. That function has noise reduction of the analog electrical signals 68 and 70 using the correlated double sampling (CDS), and digitization, i.e. analog-to-digital (A/D) conversion, of the noise-reduced analog electrical signals 68 and 70. Although the preprocessor 16 is supplied with the two-channel analog electrical signals 68 and 70, when it is supplied with a one-channel input, the CDS sampling and A/D conversion are accordingly controlled by the drive mode control 32 so as to operate for only one channel. The preprocessor 16 outputs, corresponding to the two-channel inputs, two-channel output signals 72 and 74 to the input image adjuster 18.

The input image adjuster 18 has a function of sampling the output signals 72 and 74, which are concurrently supplied in the form of two-channel outputs, at a frequency, for example, twice as high as the frequency of the output signals, to take in the output data, i.e. the image data of each channel. The input image adjuster 18 is not limited to the above-described function, but may be adapted to store the supplied output signals 72 and 74 in respective memories not shown. The obtained output signal 76 is supplied, over the bus 78 and signal line 80, to the rearranging circuit 20.

The rearranging circuit 20 has a function of rearranging the image data obtained as the two-channel outputs to correct the arrangement of the pixel data into a dot-sequential manner corresponding to a scanning line, for example, to combine the data into a single picture. The input image adjuster 18 and rearranging circuit 20 may not adjust the inputted image or rearrange the pixel data when the preprocessor 16 outputs one channel. The rearranging circuit 20 outputs the obtained image data, over the signal line 80, bus 78, and signal line 82, to the signal processor 22.

The signal processor 22 has a function of synchronizing the supplied image data, and using the synchronized image data to generate a luminance and chrominance (Y/C) signal. The signal processor 22 also has a function of converting the generated Y/C signal into, for example, a signal applicable for a liquid crystal monitor. The signal processor 22 also has a function of compressing the generated Y/C signal depending on the recording mode, and expending the compressed signal to restore or reproduce the signal. The recording mode includes JPEG (Joint Photographic Experts Group), MPEG (Moving Picture Experts Group), and raw data modes and the like. The signal processor 22 supplies the image data processed in the recording mode, over the signal line 82, bus 78, and signal line 86, to the medium control 36. The signal processor 22 delivers to the monitor 40 the signal 84 in the form appropriate for a liquid crystal monitor.

The clock generator 24 has a function of generating a reference clock signal 90. The clock generator 24 generates the clock signal 90 in response to the control signal 88 fed from the system control 30. The clock generator 24 outputs the generated clock signal 90 to the timing signal generator 26. The clock generator 24 preferably also has a function of generating the clock signal depending on the sampling frequency of the output signals 72 and 74.

The timing signal generator 26 has a function of generating various timing signals such as vertical and horizontal synchronous signals for the imaging subsection 14, a field shift gate signal, vertical and horizontal timing signals, and an overflow drain (OFD) signal. This function generates various timing signals 94 in response to the control signal 92 fed from the drive mode control 32. The timing signal generator 26 outputs the various timing signals 92 to the driver 28. In particular, the timing signal generator 26 supplies the driver 28 with a horizontal timing signal that drives, in response to the control signal 92, the horizontal transfer path 46 in two-output or one-output mode. The timing signal generator 26 also has a function of generating various sampling signals and an operational clock for use in the imaging subsection 14 as well as in various portions including, for example, the preprocessor 16 in the camera 10. The timing signal generator 26 supplies various sampling signals 96 to the drive mode control 32.

The driver 28 has a function of using the supplied various timing signals 94 to generate, depending on its drive mode, the vertical and horizontal drive signals. The driver 28 supplies the vertical and horizontal drive signals 98 to the imaging subsection 14.

The system control 30 has a function of generating various control signals in response to the operation signal 100 from the control panel 34 as described below. The system control 30 includes, as shown in FIG. 11, a setting/operation-responsive control functional block 102 and a power determination control functional block 104.

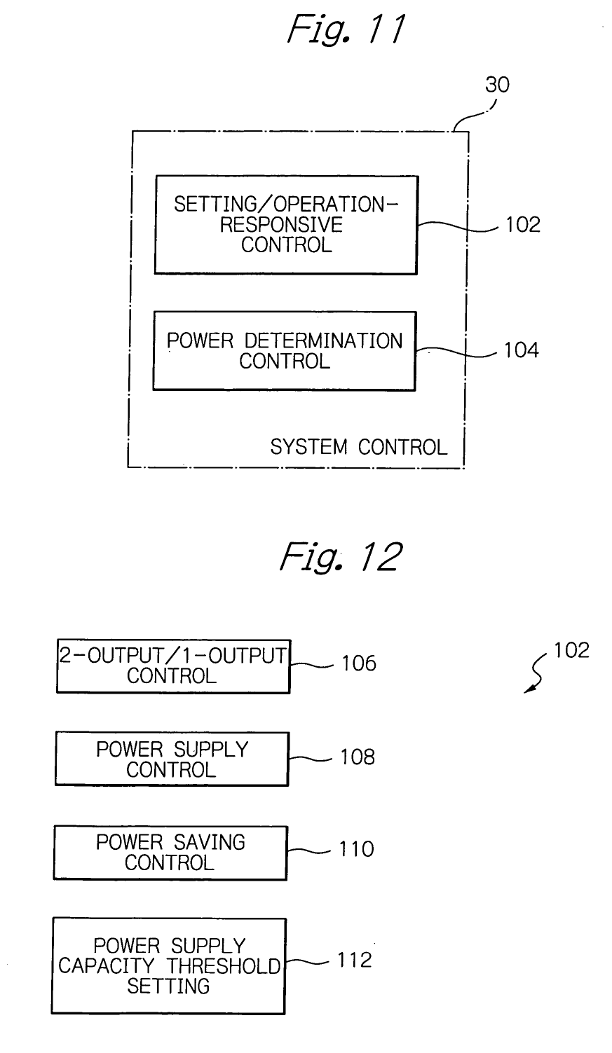

The setting/operation-responsive control functional block 102 serves as acquiring the operation signal 100 from the control panel 34 as a set condition, and generating, depending on the set condition, the various control signals. The setting/operation-responsive control functional block 102 includes, as specifically shown in FIG. 12, a two-output/one-output control functional block 106, a power supply control functional block 108, a power saving control functional block 110, and a power-supply capacity threshold setting functional block 112. The two-output/one-output control functional block 106 generates a control signal that sets, depending on a motion picture mode setting as described below and a continuous-shooting speed setting, and in response to a shutter release button depressed, the output from the horizontal transfer path 46 to either of the two-output and one-output modes, and outputs a control signal 114 to the drive mode control 32 shown in FIG. 1, for example.

The power supply control functional block 108 has a function of generating a control signal that controls the supply/disconnection of the electric power under the control of the two-output/one-output control functional block 106. The power saving control functional block 110 has a function of generating a control signal that controls, under the control of the two-output/one-output control functional block 106, the normal voltage/voltage drop of the working voltage. For example, the power saving control functional block 110 may provide control, for the one-output control, in such a way that the one output channel to be operated is supplied with lower power or voltage, and the output channel to be inoperable is supplied with much lower power. This may be controlled by the power supply control functional block 108. The power-supply capacity threshold setting functional block 112 has a function of presetting a threshold of the capacity of the power supply, and supplying the setting to the power determination control functional block 104. The threshold value thus set is supplied from the control panel 34.

The power determination control functional block 104 uses the type and threshold of power supply and the user setting as the determination condition, and makes a determination depending on at least one of the type and threshold of power supply, and user setting, or a combination thereof, and generates a control signal that achieves operation depending on the power.

Referring again back to FIG. 1, the system control 30 also generates a control signal 88 to operate the clock generator 24. The system control 30 also generates a control signal 116 for the constituent elements of the camera 10, which include, for example, the input image adjuster 18, rearranging circuit 20, signal processor 22, and medium control 36 and the like. In this way, the system control 30 outputs the generated control signals 88, 114, and 116 to the clock generator 24, drive mode control 32, and above-described portions over the bus 78, respectively.

The drive mode control 32 has a function of generating, in response to the supplied control signal 114, the control signal 92 for the timing signal generator 26, and supplying the sampling signal 96 from the timing signal generator 26 to the selected preprocessor 16. The drive mode control 32 supplies the preprocessor 16 with sampling signals 118 to 124. The drive mode control 32 controls the supply of the sampling signals 118 to 124 for the two-channel CDS circuit and A/D converters, not shown.

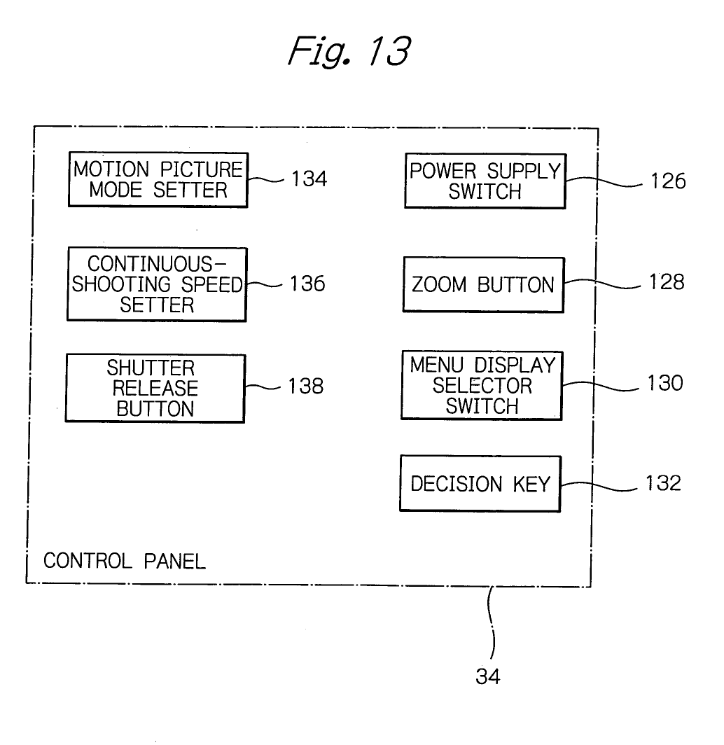

The control panel 34 includes, as collectively shown in FIG. 13, a power supply switch 126, a zoom button 128, a menu display selector switch 130, a decision key 132, a motion picture mode setter 134, a continuous-shooting speed setter 136, and a shutter release button 138. The power supply switch 126 is adapted to turn on and off the power supply of the digital camera 10. The zoom button 128 is adapted to instruct zooming operation, specifically modifying the angle of field of the subject field including a subject to be shot to adjust the focal distance of the subject depending on that modification. The menu display selector switch 130 is a switch for instructing the selection of menus to be displayed on the liquid crystal monitor 40 and moving the selector cursor displayed on the monitor 40. The menu display selector switch 130 may be implemented by, for example, a cross-bar type key or the like. The decision key 132 is a key for instruction a decision of a menu item selected.

The motion picture mode setter 134 is used to decide whether to display a motion picture on the liquid crystal monitor 40, and sets the decision in the form of, for example, a value of flag. This setting allows the monitor 40 to display the image of a subject field captured in the through-picture mode. The motion picture mode setter 134 has items for setting a picture resolution, the number of frames to be displayed, and a continuous-shooting speed. The resolution item is designated for selecting, for example, the resolution of VGA (Video Graphics Array) specifications, HDTV (High-Definition TeleVision) specifications/standard. The number of frames to be displayed is designated for selecting either of 30 and 15.

The continuous-shooting speed setter 136 has a plurality of continuous-shooting speeds provided, from which one is selected depending on the two-output or one-output mode. Continuous-shooting speeds may be set to a value appropriate for an image formed of a specific number of pixels. Continuous-shooting speeds are selectable in dependent upon whether or not the rate of continuous-shooting frames is less than a predetermined threshold for continuous shooting in such a fashion that if the rate is less than the threshold the one-output mode is selected and otherwise the two-output mode to drive the solid-state image sensor 44.

The shutter release button 138 is depressed for selecting, in response to its half or full stroke depressing, the operational timing and mode of the digital camera 10. The shutter release button 138 renders, in response to its half-stroke depression, the automatic exposure (AE) and automatic focusing (AF) operations of the camera 10. These operations allows an image obtained and display in the motion picture to determine an appropriate aperture stop value, shutter speed, and focal distance. The shutter release button 138 also defines and sends, in response to its full-stroke operation, the timing of the recording start and end to the system control 30, and provides the operational timing suitable for the set mode of the digital camera 10. The set mode includes a still image recording and a motion picture recording and the like.

The medium control 36 has an interface control function that controls, depending on a recording medium to be handled, the recording and reproduction of image data. The medium control 36 may control the write in and read out of image data 140 to and from a PC (Personal Computer) card, which is a semiconductor recording medium, or may control the write in and read out responsive to a USB (Universal Serial Bus) controller built therein. The recording medium 38 conforms to various semiconductor-card specifications.

The display monitor 40 may be implemented by a liquid crystal display device or the like. The monitor 40 visualizes and displays the image data 84 supplied from the signal processor 22.

The system configuration described above may optimize the operation of the digital camera 10, depending on whether the signal charges are read out from the horizontal transfer path 46 in the two-output or one-output mode.

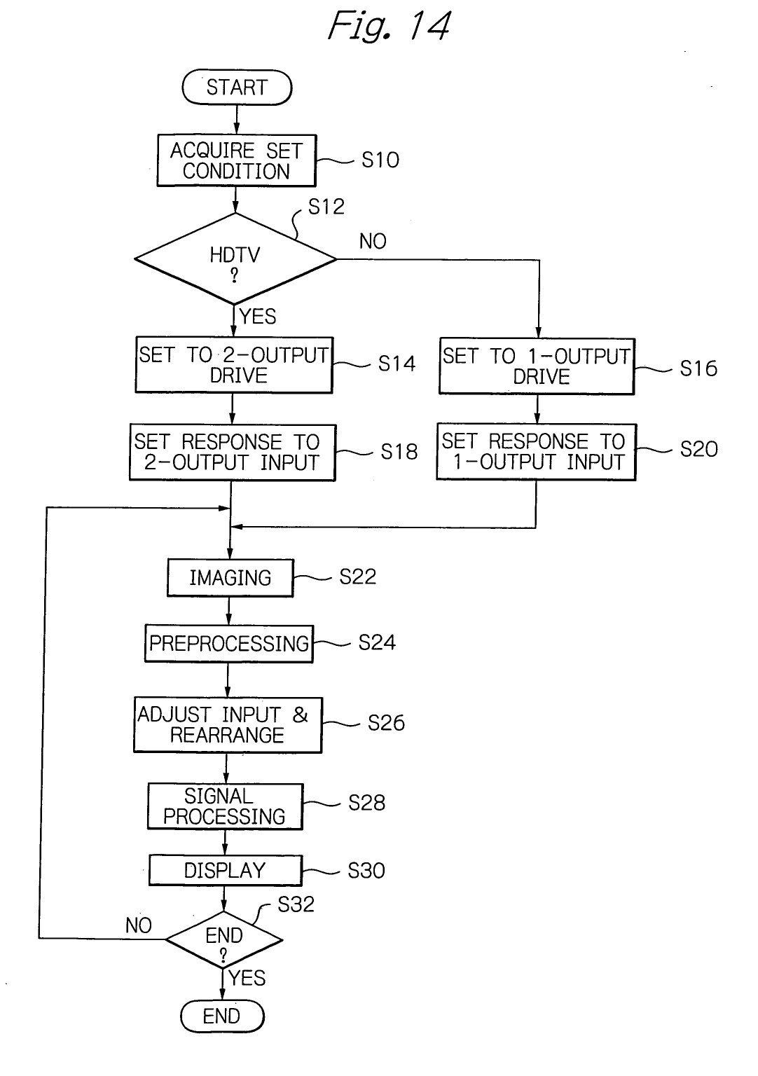

The general operation of the digital camera 10 will be described briefly. Referring now to FIG. 14, the digital camera 10 acquires, in response to the power supply turned on, the preset set condition (step S10). It is then determined whether the set condition is HDTV (step S12). If the HDTV condition is set as the picture resolution (YES), then the control passes to the two-output drive setting (step S14). If the VGA condition is set as the resolution (NO), the control passes to the one-output drive setting (step S16).

The control signal 114 then sets the timing signal generator 26 to the two-output drive condition (step S14). The control signal 114 also sets the timing signal generator 26 to the one-output drive condition (step S16).

In response to the two-output drive setting condition, the system control 30 generates, by the two-output/one-output control functional block 106, the control signal 114 that controls the horizontal transfer of the imaging subsection 14 in two-output. The control signal 114 is outputted to the drive mode control 32 as well as to the input image adjuster 18 and rearranging circuit 20 (step S18). Particularly, the drive mode control 32 is set, in response to the two-output inputs, to supply to the preprocessor 16 the two-channel sampling signals 118 to 124.

In response to the one-output drive setting condition, the system control 30 generates, by the two-output/one-output control functional block 106, the control signal 114 that controls the horizontal transfer of the imaging subsection 14 in the one-output mode. The control signal 114 is outputted to the drive mode control 32 as well as to the input image adjuster 18 and rearranging circuit 20. The drive mode control 32 is set, in response to the one-output instruction input, to supply to the preprocessor 16 the one-channel sampling signals 118 and 122.

After the setting, a subject field is imaged (step S22). The imaging subsection 14 reads out the image signal obtained during the imaging on the outputs the number of which depends upon the setting, and outputs the image signal to the preprocessor 16. The preprocessor 16 provides the noise reduction and digitization (step S24). Particularly, in the two-output mode, the preprocessor 16 uses the supplied sampling signals 118 to 124 to provide the noise reduction and digitization on the image signals 68 and 70. In the one-output mode, the preprocessor 16 uses the supplied sampling signals 118 and 122 to provide the noise reduction and digitization on the image signal 68. In the one-output mode, the preprocessor 16 processes at a speed that is lower than in the two-output mode and is the same as in the conventional technology.

The image input adjuster 18 and rearranging circuit 20 provide, in the one-output mode, pass the supplied image data 72 therethrough, and supply the passed data to the signal processor 22. Conversely, in the two-output mode, the supplied image data 72 and 74 are concurrently taken into the image input adjuster 18, and the image data 80 thus taken in is rearranged by the rearranging circuit 20. The rearranging circuit 20 thus provides a frame of image and outputs the image data representative of the frame of image to the signal processor 22.

The signal processor 22 synchronizes the supplied image data 82 and processes the synchronized image data into the Y/C data depending on the resolution (step S28). The signal processor 22 displays the image data 84 converted for the liquid crystal monitor (step S30). After the display, it is determined whether to end the process (step S32). When the operation signal 100 instructing the end is supplied (YES), the digital camera 10 stops the operation. When the operation signal 100 indicates continuation or no instructions (NO), the operation is continued to step S22 and the above-described series of processings starting at the imaging will be repeated. For the operation to continue, the control may return to the determination step S12 on whether the resolution is of the HDTV.

The operation stated above may read out from the imaging subsection 14 the image signal at the optimum frame rate and display it.

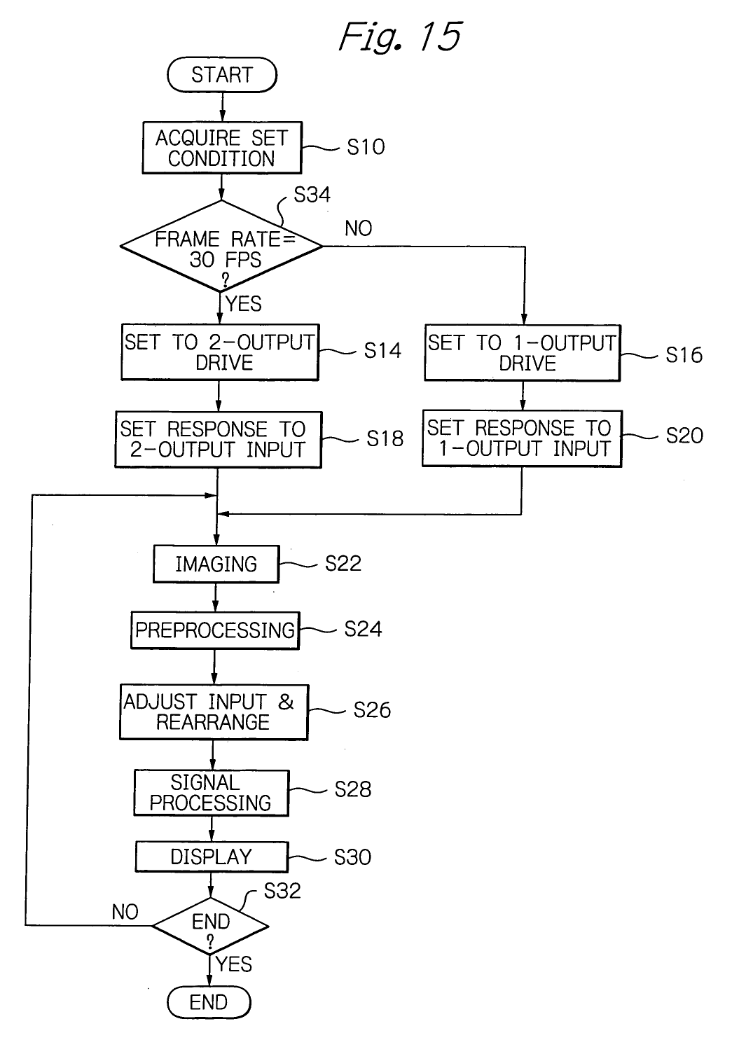

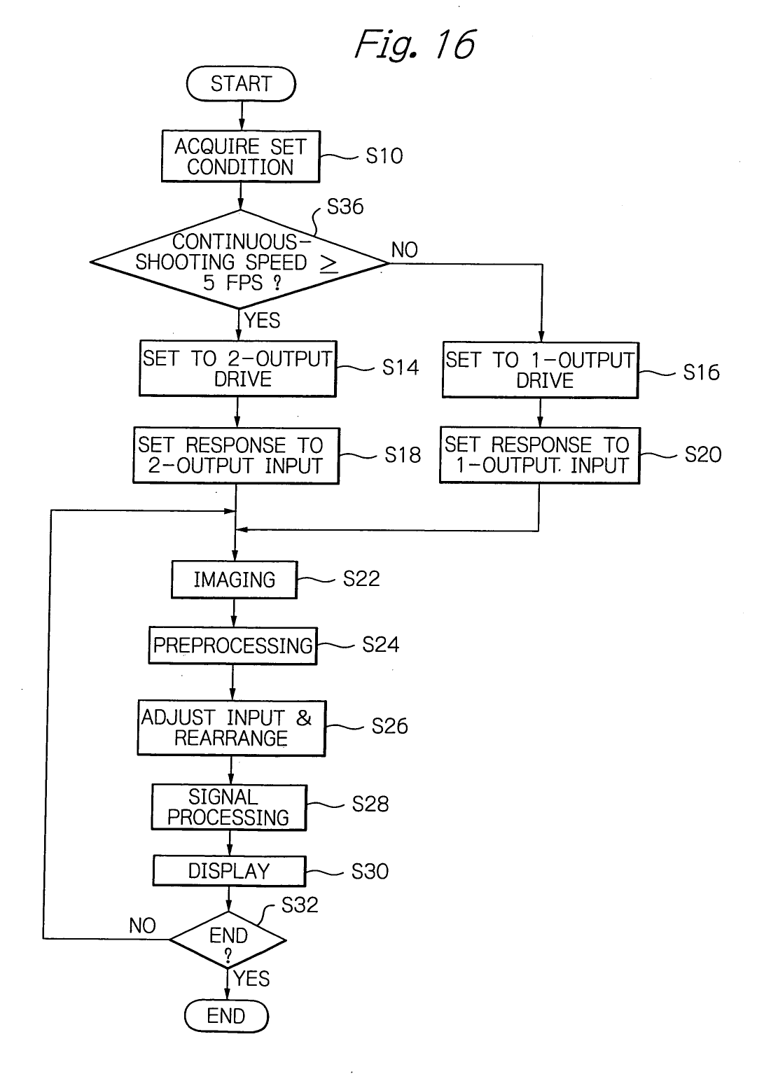

The digital camera 10 may be adapted for, in addition to providing control depending on the resolution, providing control depending on the displayed frame rate. FIG. 15 is a flowchart for this case. In the subsequent procedures including FIG. 15, the same procedures as in FIG. 14 will be provided with the same reference numerals, and their description will not be repeated for simplicity. In FIG. 15, the digital camera 10 determines, after acquiring the set condition, whether the frame rate is 30 frames/second (step S34). If it is 30 frames/second (YES), then the control passes to the two-output drive setting (step S14). If it is set to 15 frames/second (NO), then the control passes to the one-output drive setting (step S16). In this way, the system may be adapted to provide the operational speeds of reading out signal charges in dependent upon the vertical drive or scanning frequency. The system thus adapted may be compatible with a restriction of displaying an image on the monitor 40 and the like.

The digital camera 10 may be adapted for switching the control in dependent upon the continuous-shooting speed. Referring to FIG. 16, the digital camera 10 determines, after acquiring the set condition, whether or not the continuous-shooting speed is five frames/second or more (step S36). If it is five frames/second or more (YES), then the control passes to the two-output drive setting (step S14). If it is set to less than five frames/second (NO), then the control passes to the one-output drive setting (step S16). In this way, it is preferable to differ the continuous-shooting speed associated with the image reading speed in dependent upon the speed of reading out signal charges from the solid-state image sensor 44. The system thus adapted may comply with a restriction on recording images.

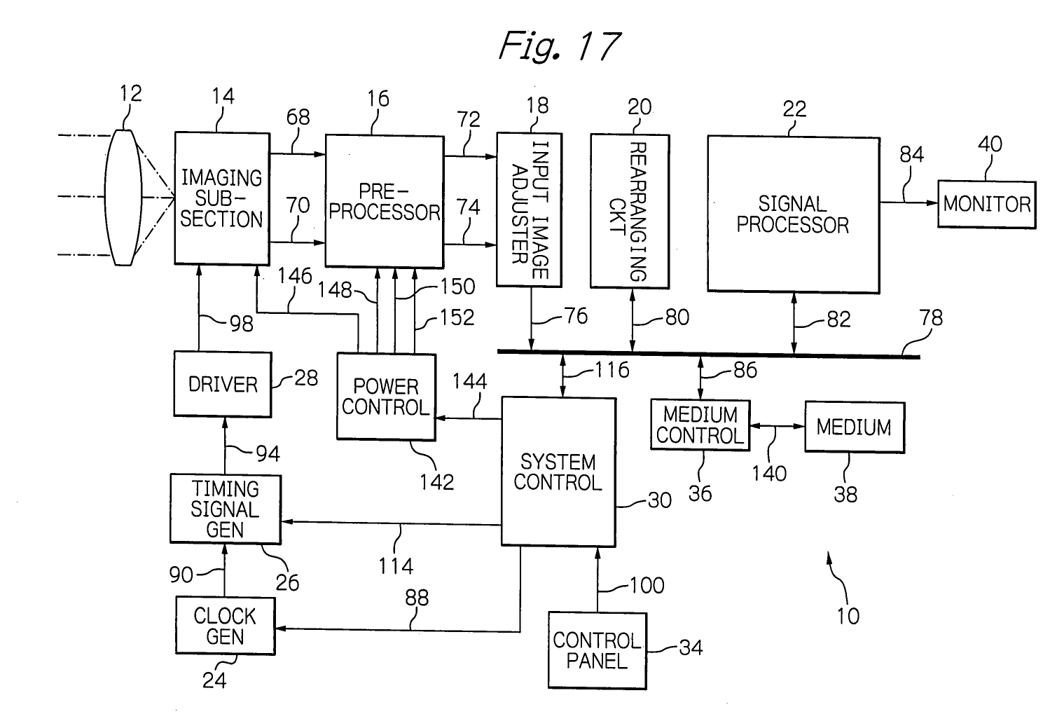

FIG. 17 shows an alternative embodiment in which the digital camera 10 is adapted to control the electric power depending on its operation. Subsequently, the constituent elements or portions common to the illustrative embodiment shown in and described with reference to FIG. 1 will be designated with the same reference numerals and their description will not be repeated. The digital camera 10 shown in FIG. 17 includes in addition to the components shown in FIG. 1 an additional component characterizing this embodiment, that is, a power control 142.

The power control 142 has a function of controlling, in response to the control signal 144, the power supply to the output gates (OG) and amplifier disposed in the image sensor 44, and to the CDS circuit and A/D converter contained in the preprocessor 16. The power control 142 controls the power supply by turning on or off, at least, the power supply to the OG gates and amplifier and the like, when not used, in the image sensor 44, and to the CDS circuit, A/D converter, and amplifier in the preprocessor 16 and the like. For that aim, the power control 142 has its power line 146 connected for turning on or off the power supply to any of the OG gates and amplifier and the like, while unused, in the image sensor 44, and the three power lines 148, 150, and 152 dedicated for the one-output channel to the preprocessor 16. The power control 142 has a power selector switch built therein that operates in response to the control signal 144, thereby controlling the power supply to the power supply lines 146 to 152. Note that power supply lines that are always supplying power are not shown in the figure. The control signal 144 is used for controlling the power supply to the preprocessor 16. The control signal 144 is generated by the power supply control functional block 108 in the system control 30.

The power control 142 is not limited to the function of turning on and off the power supply, but may be adapted for providing such a control that, when the imaging subsection 14 is controlled to its one-output channel, the power to be supplied to the output channel not operated is rendered much lower than the power supplied to the output channel made operative so as to actually operate accordingly.

Note that, although not specifically shown, if the camera 10 is adapted not to have the drive mode control 32 included in the illustrative embodiment described earlier is not provided, then the system control 30 will be adapted for supplying, as shown in FIG. 17, the generated control signal 114 to the timing signal generator 26.

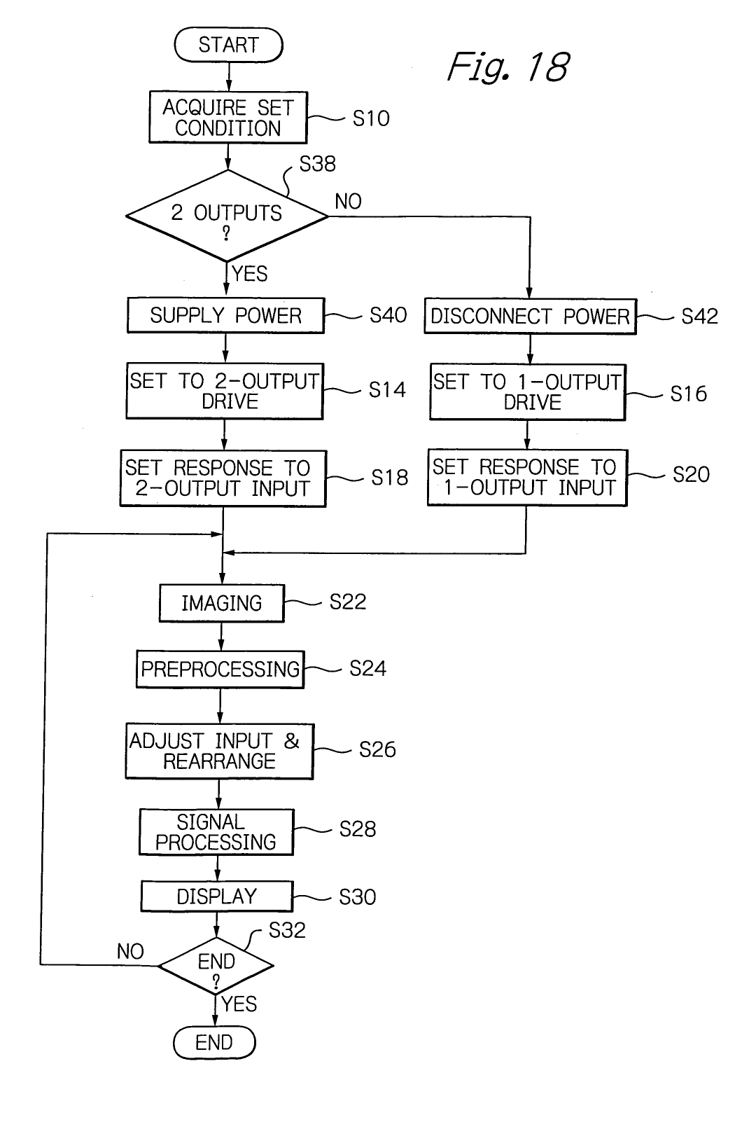

The operation of the digital camera 10 of the alternative embodiment will be described below. Referring to FIG. 18, after having acquired the set condition, the digital camera 10 determines whether the output is two-output (step S38). If it is two-output (YES), then the control passes to step S40 that supplies the power to the entire portions of the preprocessor 16. If it is one-output (NO), then the control passes to step S42 that disconnects the power supply from the output channel.

The power control 142 then sets the power to be supplied to the entire output amplifiers in the image sensor 44 and the preprocessor 16 (step S40). For the one-output power control, correspondingly to this control, the power control 142 provides control such as to restrict the power supply to the output amplifiers in the image sensor 44 and the preprocessor 16 to the one-output channel, and disconnect the power supply from the unused output amplifier in the image sensor 44 and the other output channel in the preprocessor 16 (step S42). Subsequently, the same operations as in the previous illustrative embodiment will be performed. This may decrease power consumption than in the preprocessor 16 which would otherwise be constantly supplied with the electric power.

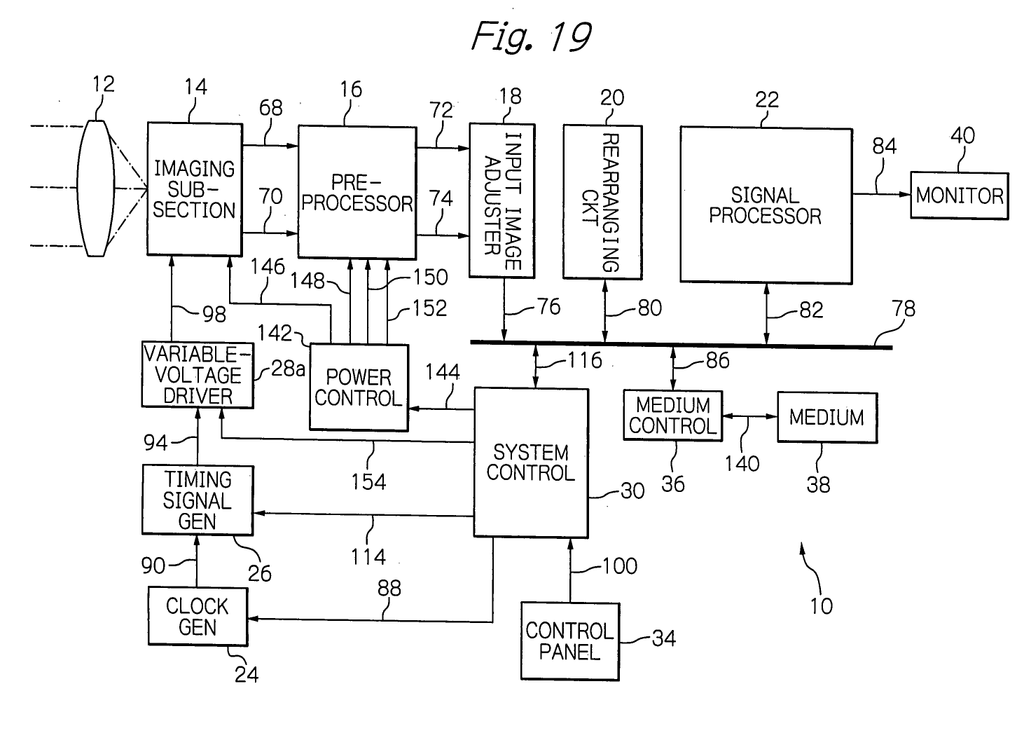

The digital camera 10 may include in addition to the configuration shown in FIG. 17 a variable-voltage driver 28a as shown in FIG. 19. The variable-voltage driver 28a shown in FIG. 19 has a function of changing or adjusting its output drive voltage in response to the supplied control signal 154. The variable-voltage driver 28a is adapted to change the drive voltage in a range of 16V to 5V (volts), for example. The control signal 154 is generated by the power saving control functional block 110 in the system control 30.

The power saving control functional block 110 generates the control signal 154 in such a way that the drive voltage of 16V or 5V is applied for the two-output or one-output mode, respectively.

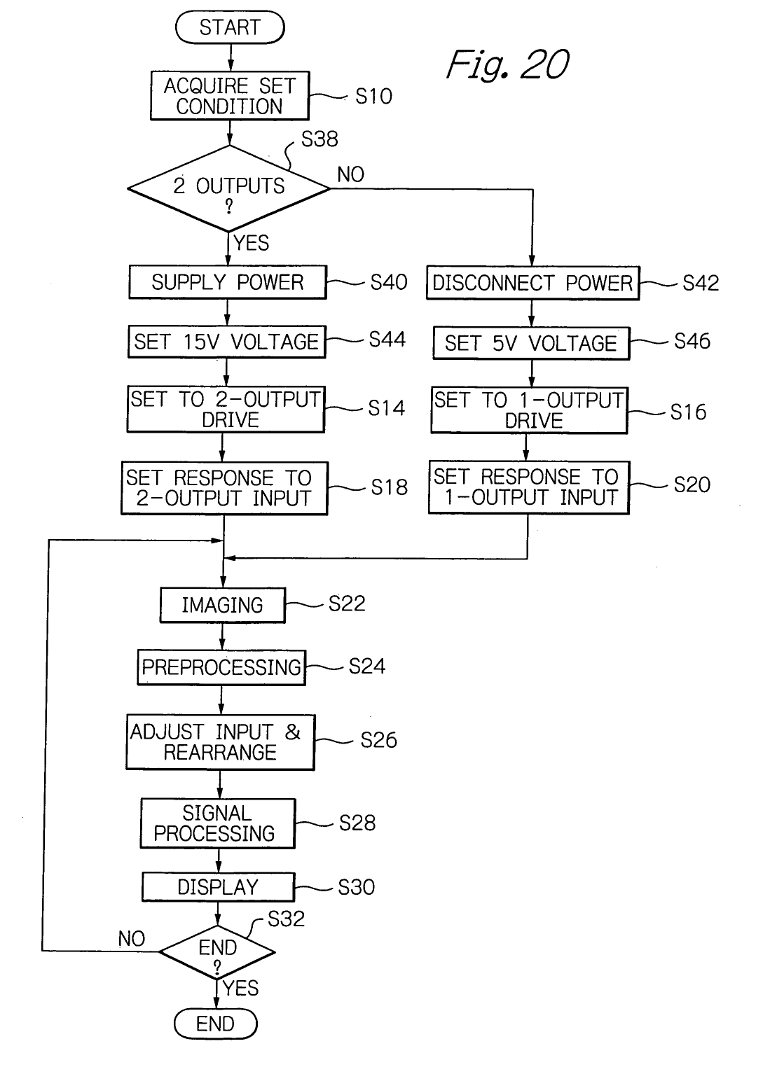

FIG. 20 is useful for understanding the operation for this case. After acquiring the set condition, the digital camera determines whether the output is two-output (step S38). If it is two-output (YES), then the control passes to step S40 in which the power is supplied to the entire preprocessor 16. If it is one-output (NO), then the control passes to step S42 that disconnects the power supply from the output channel.

The power control 142 then sets the power supply to the entire output amplifiers in the image sensor 44 and the preprocessor 16 (step S40). For the one-output power control, correspondingly to this control, the power control 142 controls the power supply to restrict the output amplifier in the image sensor 44 and the preprocessor 16 to the one-output channel, and disconnect the power supply from the unused output amplifier in the image sensor 44 and the other output channel in the preprocessor 16 (step S42).

After having controlled the power supply in that way, in the two-output mode, the drive voltage of the image sensor 44 is further set to 15V (step S44), whereas, in the one-output mode, the drive voltage of the image sensor 44 is set to 5V (step S46). Subsequently, the same operations as in the previous embodiments will be performed. These operations may further decrease the power consumption, and also prevent electric charges from flowing back in the image sensor 44.

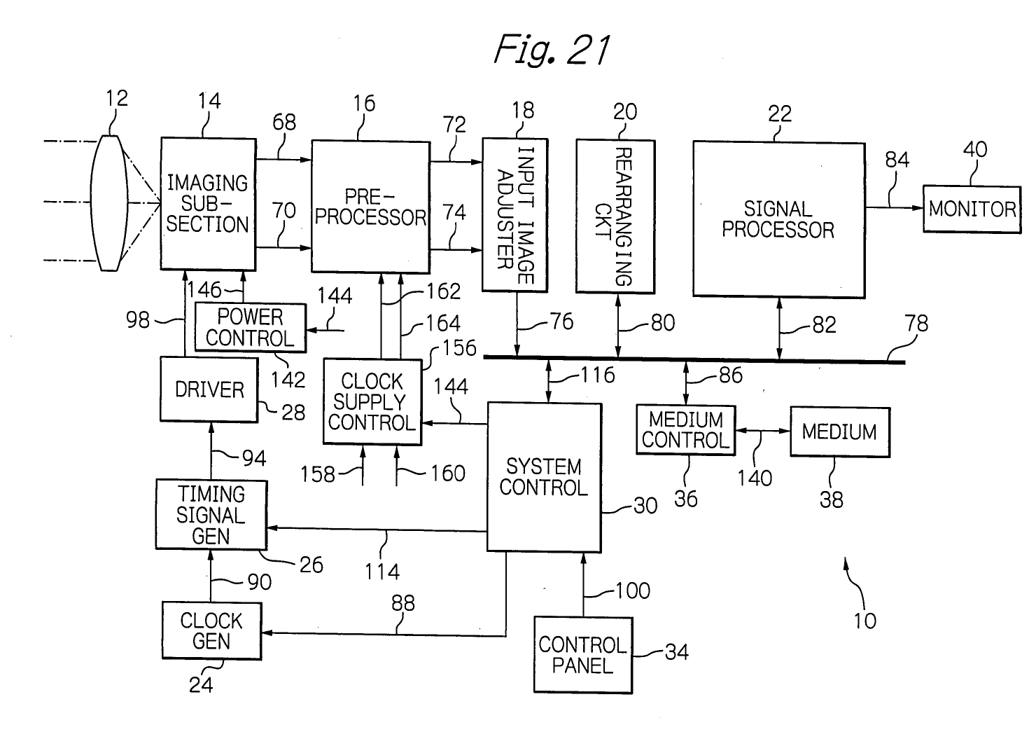

The power supply to the digital camera 10 is not limited to the configuration example in the alternative embodiment, but may also be controlled by connecting or disconnecting the clock signal to the CDS circuit and A/D converter in the preprocessor 16. The CDS circuit and A/D converter stop their operations in response to the clock-signal disconnection, and the stoppage of the operation terminates the power consumption. In this case, the digital camera 10 is preferably configured as shown in FIG. 21. This alternative embodiment includes not only the power control 142 but also a clock supply control 156. The power control 142 is adapted for controlling only the power supply to the image sensor 44 over the power line 146.

The clock supply control 156 has a function of controlling the connection and disconnection of the sampling clock signal supplied to the CDS circuit and A/D converter in the preprocessor 16. The clock supply control 156 is supplied with clock signals 158 and 160 from the clock generator 24 or timing signal generator 26. The clock supply control 156 operates in response to the control signal 144 generated by the power saving control functional block 110. Particularly, the clock supply control 156 has its clock supply lines 162 and 164 connected to the CDS circuit and A/D converter, even when not in use. The clock supply control 156 has a selector switch, not shown, which turns on and off the clock supply in response to the control signal 144.

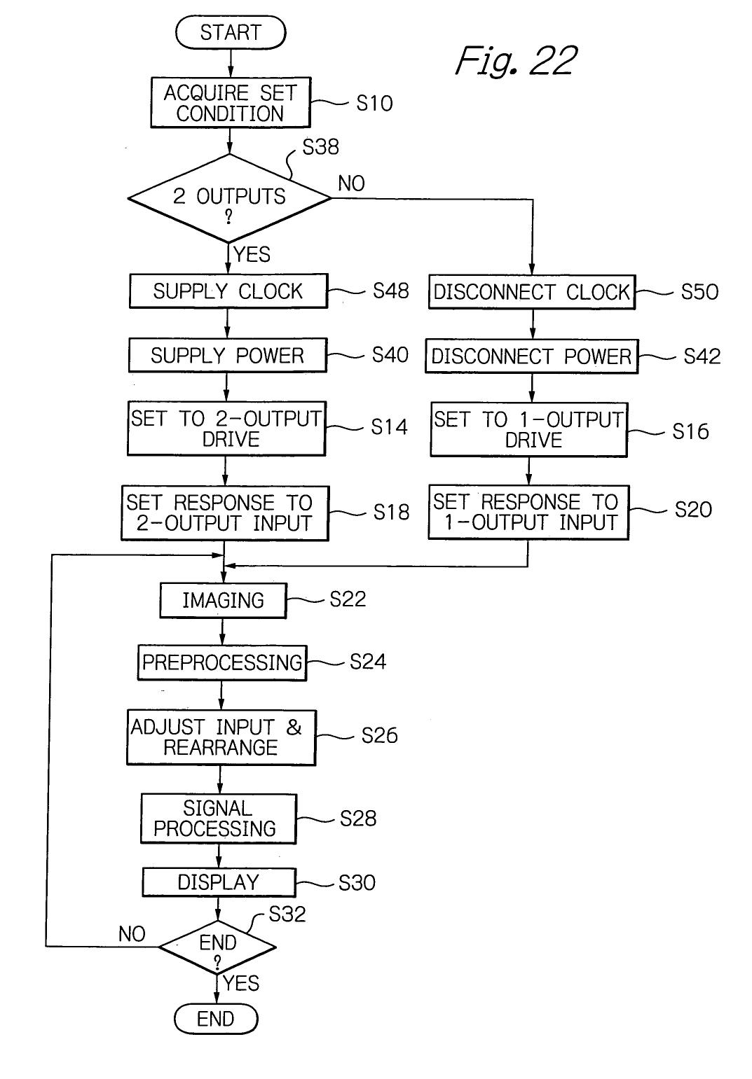

The operation of the digital camera 10 will be described below. Referring to FIG. 22, the digital camera 10 determines, after acquiring the set condition, whether the output is two-output (step S38). If it is two-output (YES), then the control passes to step S48 that supplies the clock signals 162 and 164 to the preprocessor 16. If it is one-output (NO), then the control passes to step S50 which disconnects the supply of the clock signal of the one-output channel.

In the two-output mode, the preprocessor 16 is supplied with the clock signals 162 and 164 for the two output channels (step S48). In the one-output mode, the one output channel is supplied with the power, and the other output channel has the supply of the clock signal disconnected (step S50).

The power control 142 then sets all the output amplifiers in the image sensor 44 to be supplied with the power (step S40). For the one-output power control, correspondingly to this control, the power control 142 provides control in such a way that the output amplifier in the image sensor 44 is limited to the one-output channel and is supplied with the power, and the power supply to the unused output amplifier in the image sensor 44 is disconnected (step S42).

After the power supply control thus performed, the same operations will be carried out as in the illustrative embodiments previously described. The operations described above may also further decrease the power consumption.

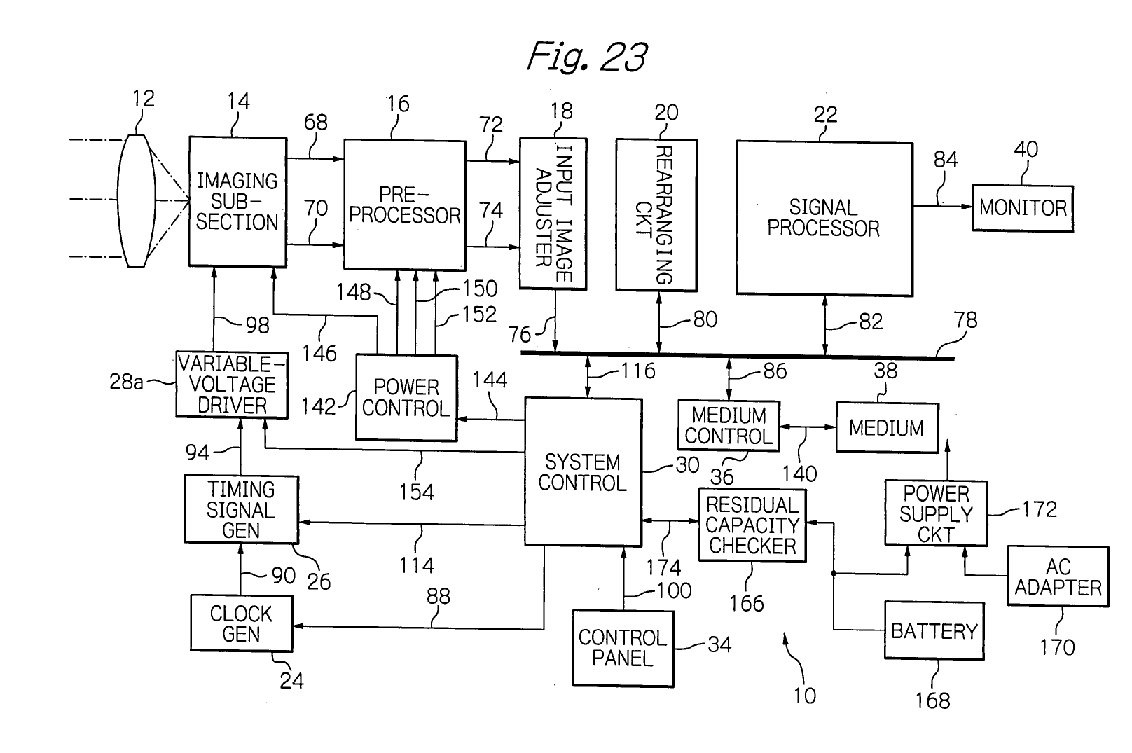

The digital camera 10 may be adapted for, in addition to controlling the power consumption during the imaging operation, controlling the power supply depending on the capacity of the power supply. FIG. 23 shows a configuration example in the latter power control.

The digital camera 10 shown in FIG. 23 includes the configuration in FIG. 19 plus a residual capacity checker 166. The digital camera 10 of the alternative embodiment also includes the usual components such as a battery 168, an AC (Alternate Current) adapter 170, and a power supply circuit 172. The residual capacity checker 166 has a function of, for example, acquiring a capacity threshold from the power-supply capacity threshold setting functional block 112 included in the system control 30, and comparing the residual capacity of the battery 168 with the capacity threshold to determine whether or not the residual capacity is satisfactory. The residual capacity checker 166 receives and sends the capacity threshold and determination result 174 from and to the system control 34, respectively. The battery 168 is connected to the residual capacity checker 166. The power supply circuit 172 is connected with the battery 168 and AC adapter 170. The power determination control functional block 104 in the system control 30 generates the control signal 144 depending on the determination result indicating whether the residual capacity satisfies, i.e. equals to or exceeds, the threshold.

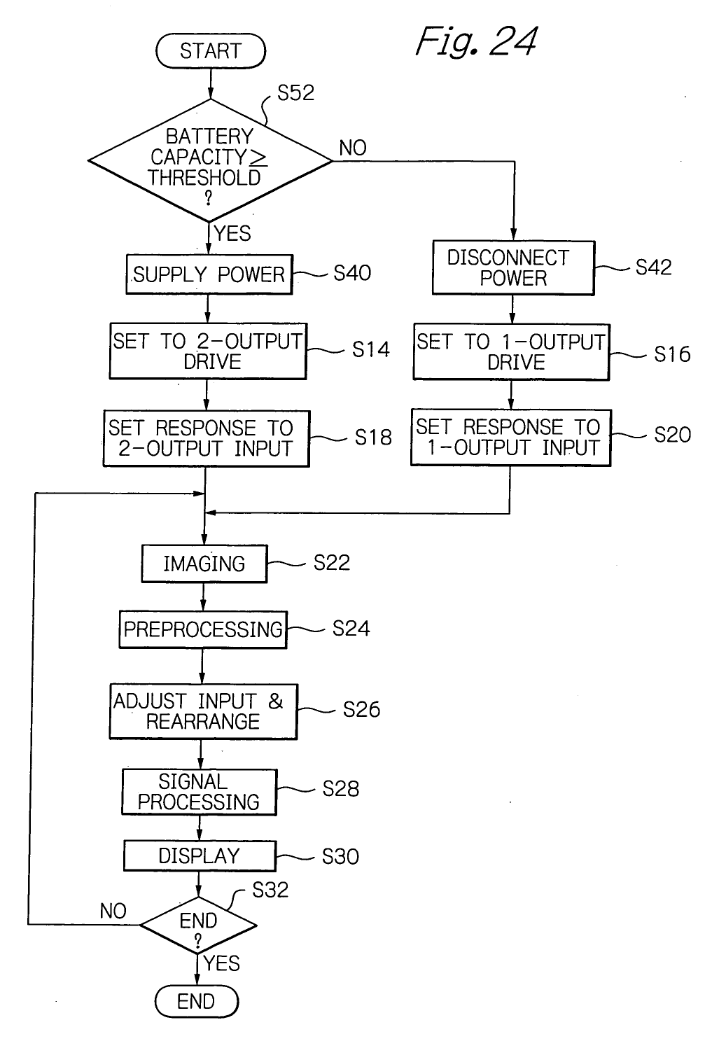

FIG. 24 shows the operational procedure for this case. Although not shown in the procedure in FIG. 24, the power supply is turned on and the set condition is acquired in advance (step S10). After acquiring the set condition, the digital camera 10 determines whether or not the residual capacity of the battery 168 is equal to or more than the battery capacity threshold 174 (step S52). If it is determined that the residual capacity is equal to or more than the battery capacity threshold 174 (YES), then the control transfers to a power supply step S40. If it is determined that the residual capacity is less than the battery capacity threshold 174 (NO), then the control passes to a power disconnection step S42. Although not shown, the drive voltage outputted from the driver 28a is preferably controlled as shown in FIG. 23. Description on the subsequent procedures will not be repeated merely for simplicity. That operation may prolong the battery life of the digital camera 10.

The digital camera 10 may preferably be adapted to notify the user of the current processing to keep the battery life longer. Such a notice preferably allows, in response to the control from the system control 30, a specific symbol or character to be displayed on the monitor 40.

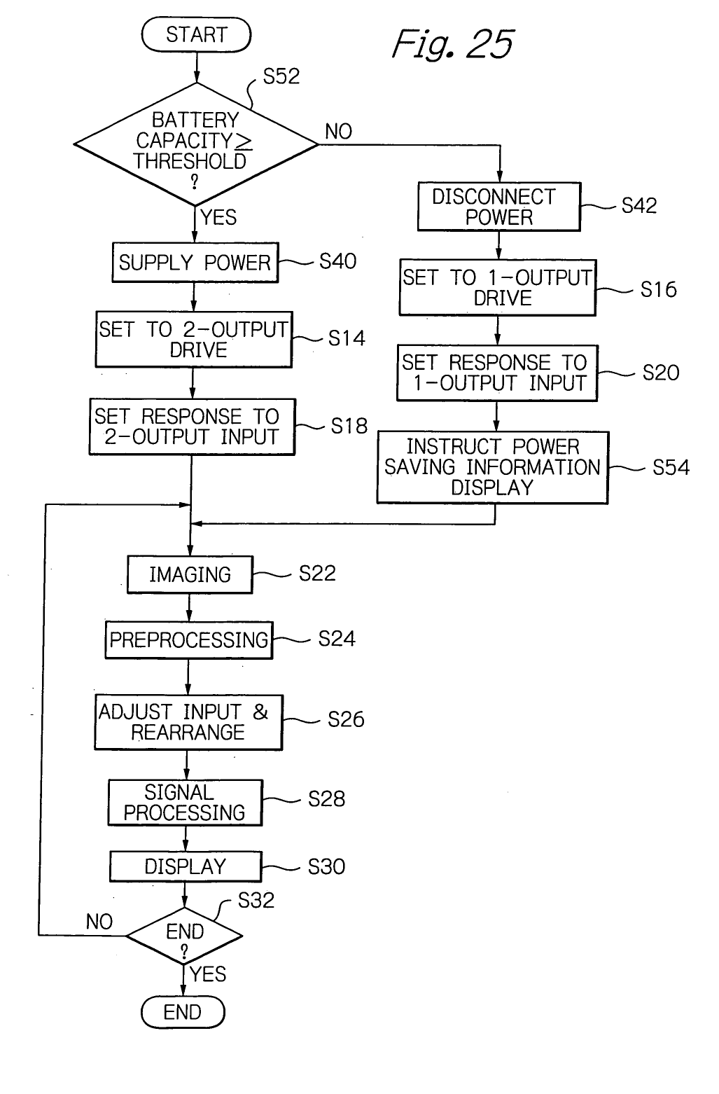

Referring to FIG. 25, the procedure therefor may be that after completing several settings for the one-output, the system control 30 instructs, after step S20 for example, to display power saving information on the monitor 40 (step S54). After the instruction of the display, a series of processings from the image shooting to the display of an image captured are sequentially performed. Of the processings, the display processing allows the monitor 40 to display a shot image of the subject field together with an indication that the digital camera is operating in the power saving mode. The user may confirm the display to know the current situation where some of the processings are rendered slow in the digital camera 10. Because the user is made aware of the situation of the digital camera 10, he or she may confirm before shooting whether or not the camera 10 is in its situation of capable of imaging.

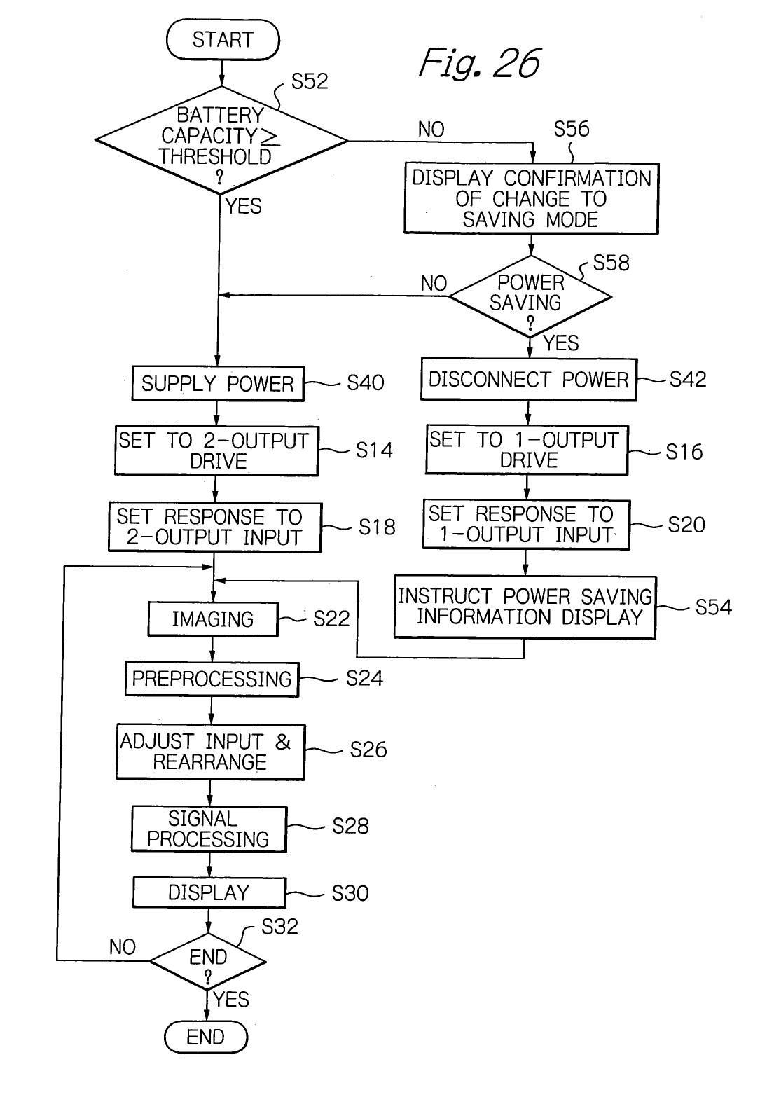

The digital camera 10 is not limited to that operates to prioritize the situation of the digital camera 10 as described above, but may perform an operation that prioritizes the user's intention. FIG. 26 shows the procedure corresponding to the latter operation. The procedure shown in FIG. 26 includes the procedure in FIG. 25 plus some processings inserted between the determination processing and the power disconnection processing in the one-output mode.

To control the digital camera 10 in its one-output mode, the system control 30 notifies the monitor 40 of the change to the power saving mode, and displays on the monitor 40 an inquiry on whether or not the change is approved (step S56).

The monitor 40 displays “YES” for approval and “NO” for disapproval. In response to the indications, the user moves the cursor and uses the decision key 132, FIG. 13, to select either of the indications. When disapproving the change to the power saving mode (NO), regardless of the little residual capacity of the battery 168, the processing for the full power condition is performed. Specifically, the digital camera 10 moves to the power supply step S40. When approving the change to the power saving mode move (YES), the digital camera 10 moves to the power disconnection processing step S42.

The operation described above may prioritize the user's intention in the processings, and hence increase the degree of freedom in selection to provide flexibly responsive processing.

The digital camera 10 is structured to be supplied with the power from, as shown in FIG. 25, either of the battery 168 and AC adapter 170. Although the digital camera 10 may use the battery 168 to provide the convenience of much portability, the battery life limits the operable time. The digital camera 10 may use the AC adapter 170 to ensure the sufficient power and unlimited operationable time. The digital camera 10 is limited, however, within the range of the cable length of the AC adapter 170. In this way, the battery 168 and AC adapter 170 have conflicting convenience.

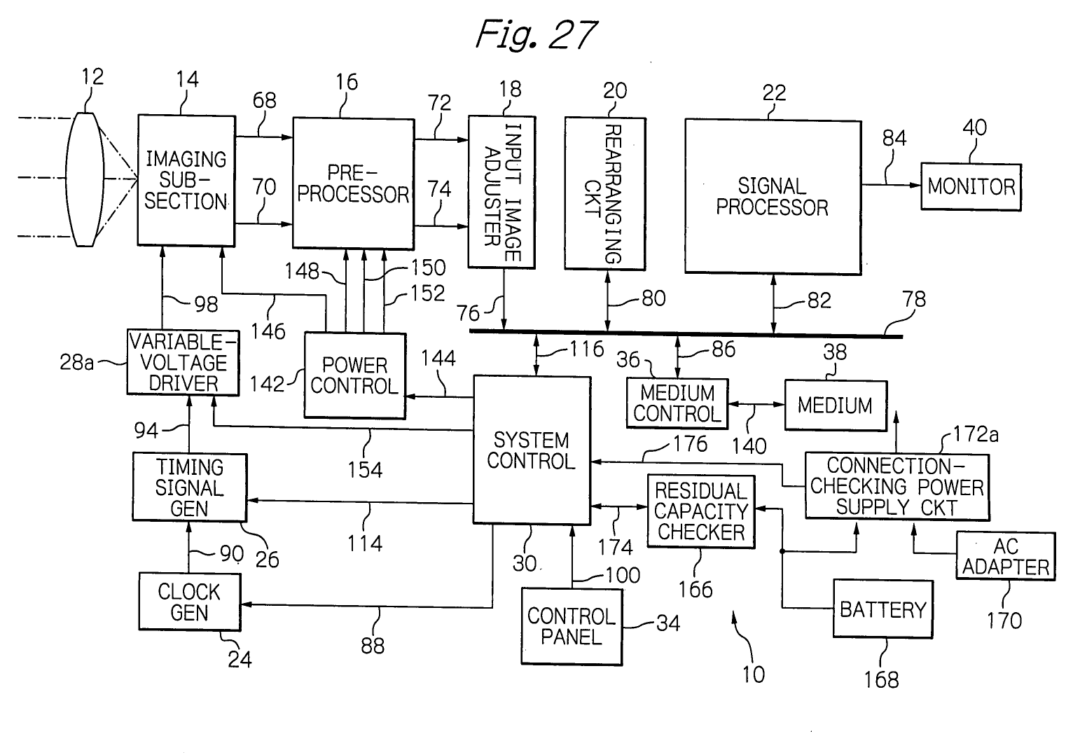

When the digital camera 10 is used considering the power supply capacity, the knowledge on whether the battery 168 or AC adapter 170 is used is effective in selecting the two-output or one-output mode. The digital camera 10 shown in FIG. 27 is then adapted to include a connection-checking power supply circuit 172a instead of the power supply circuit 172 shown in FIG. 23. The connection-checking power supply circuit 172a has a function of detecting whether the AC adapter 170 is connected or disconnected. The connection-checking power supply circuit 172a outputs a detection result to the system control 30 via a flag 176. The system control 30 allows the power determination control functional block 104 to generate the control signal 144.

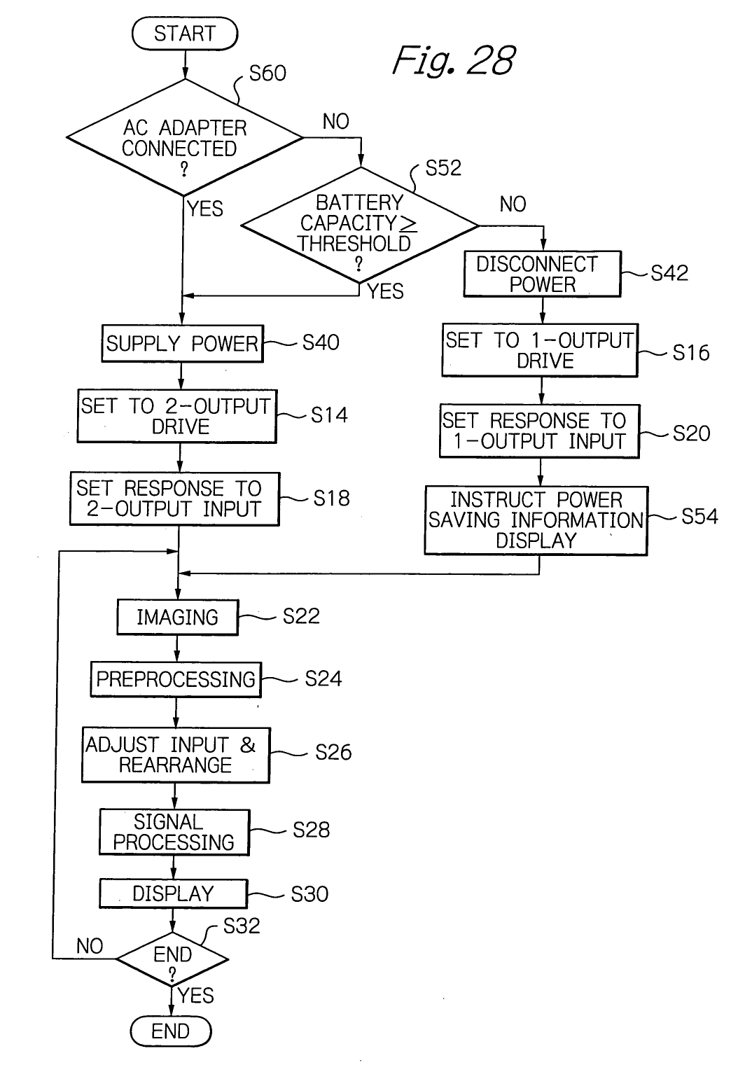

The operation of the digital camera 10 will be described below. FIG. 28 shows an operational procedure that includes the operational procedure shown in FIG. 25 plus a connection determination of the AC adapter 170 (step S60). In the procedure shown, the connection-checking power supply circuit 172a determines whether the AC adapter 170 is connected, and outputs, if the connection is detected, the flag 176 set to “1”, for example, to the system control 30. The system control 30 moves, if the power determination control functional block 104 receives the flag 176 representative of “1” (YES), which means that the power supply is sufficient, to the operational procedure in the two-output mode (step S40). The connection-checking power supply circuit 172a outputs, if the AC adapter 170 is determined to be unconnected, a flag 176 set to “0”, in this example, to the system control 30. If the power determination control functional block 104 receives the flag 176 representative of “0” (NO), then the control passes to a process that determines the residual capacity of the battery 168 (step S52). Subsequently, the digital camera 10 operates according to the procedure in FIG. 25.

That operation stated above may confirm the connection of the AC adapter 170 to always be controlled in its two-output operation, thereby providing more rapid processing than in the one-output operation.

The present invention has been disclosed with respect to the digital camera 10 having its through-picture mode, i.e. a motion picture being displayed on the monitor 40. The motion picture display is for the application not recording images, and the digital camera 10 is configured to select the two-output or one-output processing mainly depending on the image quality, read-out speed (of the continuous shooting), power supply control and the like.

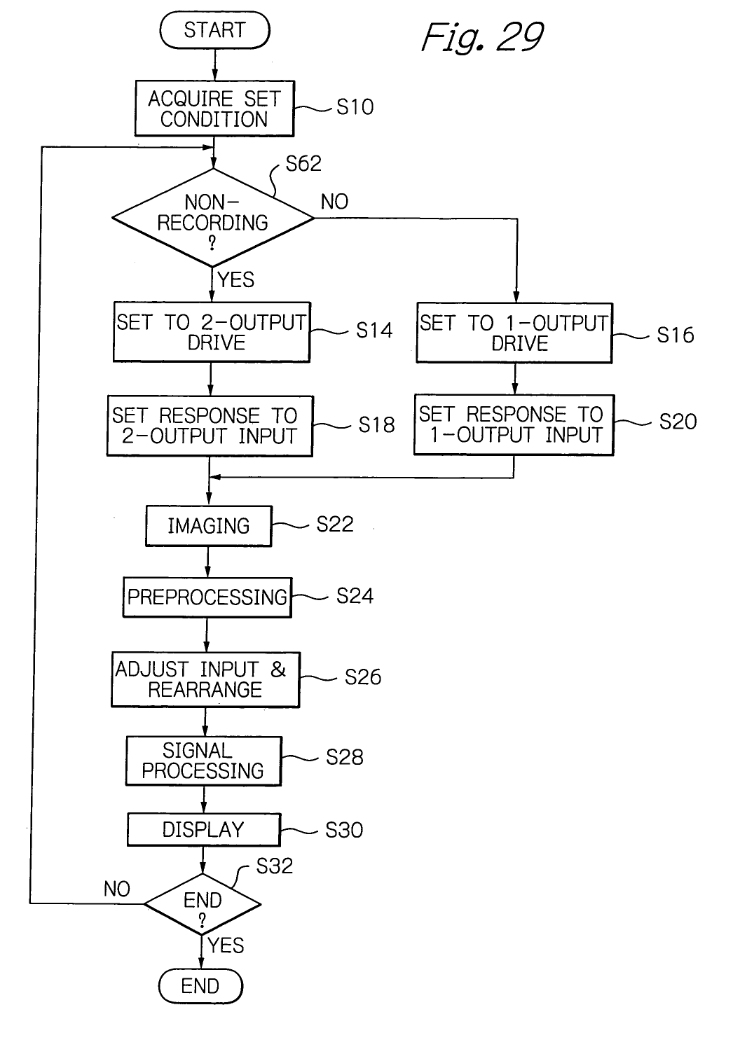

The digital camera 10 may also be adapted to select the two-output or one-output processing based on whether to record or not. The operation will be described with reference to FIG. 29 which shows a control flow carried out by the digital camera 10 shown in FIG. 1.

According to the control flow shown in the figure, the digital camera 10 first acquires the set condition (step S10). After acquiring the set condition, the digital camera 10 determines recording or non-recording depending on the set condition and the pressing operation of the shutter release button 138 (step S62). If the set condition is the motion-picture display, or the pressing operation is the half-stroke depressing condition, or the set condition is the motion-picture shooting mode (YES), then the control passes to the two-output drive setting step S14. If the setting condition is the still-image shooting mode and the pressing operation is the full-stroke depressing condition (NO), then the control passes to the one-output drive setting step S16. Subsequently, the same operations as shown in FIG. 14 will be performed. In this embodiment, non-recording corresponds to displaying and recording may also be set. The processing at step S30 is thus the display/recording processing. If the end determination determines to continue the processing (NO), then the control returns to the non-recording determination processing step S62. This is because the digital camera 10 determines the display/record in response to the depressed stroke of the shutter release button 138.

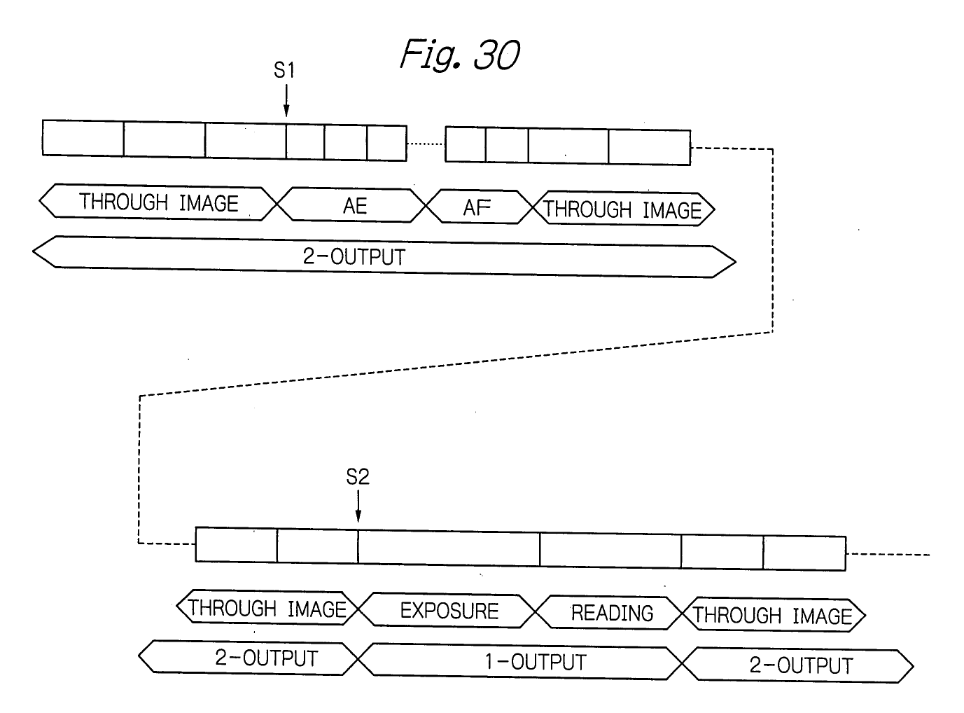

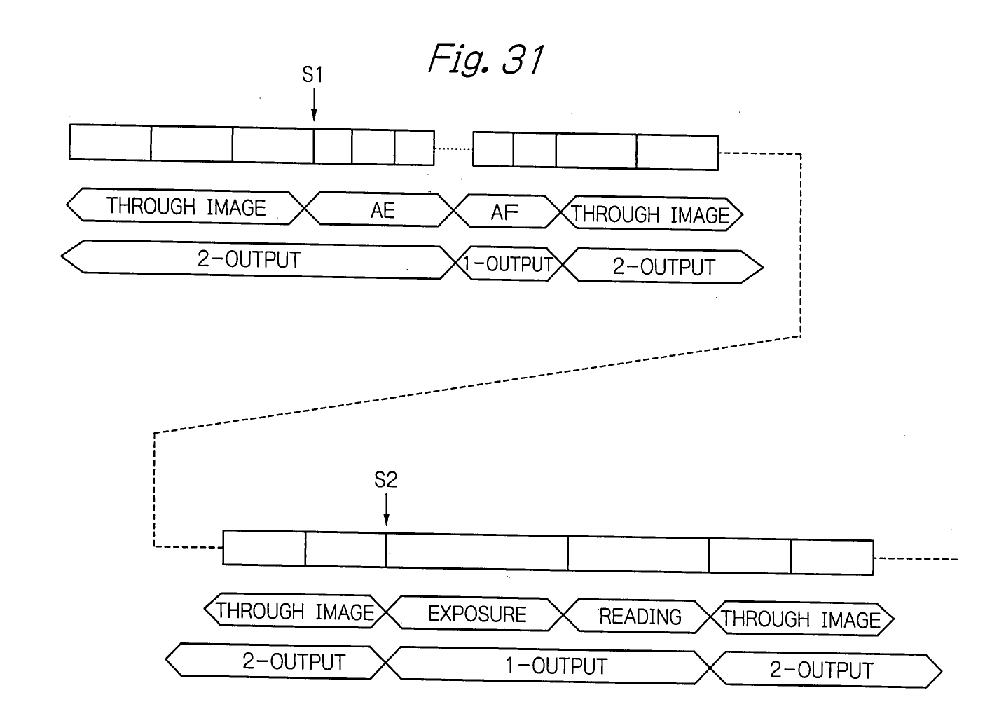

The two-output drive may be set for the through-image mode, automatic exposure, and automatic focusing, or may be set for the through-image mode and automatic exposure. Particularly, referring to FIGS. 30 and 31, the automatic exposure processing preferably uses the two-output drive after the half-stroke depressing (S1). The one-output drive may be set, as shown in FIGS. 30 and 31, during the exposure and signal charge read-out after the full-stroke depressing (S2). Referring to the timing chart shown in FIG. 31, the digital camera 10 may be set to the one-output drive during the automatic focusing processing.

That drive stated above may attain the operation in the appropriate operational environment depending on the processing speed requested in a specific mode of operation, and the higher image quality of the appropriately obtained image depending on the operation.

The entire disclosure of Japanese patent application Nos. 2005-299297, 2005-299298 and 2005-299306 all filed on Oct. 13, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What we claim is:

1. An image pickup apparatus comprising:
an image sensor for receiving incident light from an subject field and producing signal charges corresponding to the incident light, said image sensor including a plurality of output circuits for converting the signal charges to an image signal to output the image signal, said image sensor being driven depending on operational situation;
a controller for generating a control signal to control operation of said image sensor depending on a multiple-output mode or a single-output mode;
a timing generator operative in response to the control signal for generating a timing signal for said image sensor;
a drive signal generator operative in response to the timing signal for generating a drive signal;
a preprocessor for applying at least noise reduction and digitization on the image signal on an output channel corresponding to effective one of said plurality of output circuits; and
a processing controller operative in response to the control signal for controlling a processing for each of the output channels of said preprocessor,
said controller determining whether the multiple-output mode is a second speed mode faster than a first speed mode, and generating the control signal depending on a result of determination,
said processing controller controlling the processing for a one-output channel in the first speed mode, and controlling the processing for a multiple-output channel in the second speed mode.

2. The apparatus in accordance with claim 1, wherein the second speed mode is of a higher resolution than in the first speed mode.

3. The apparatus in accordance with claim 1, wherein the second speed mode is of a higher frame rate than in the first speed mode.

4. The apparatus in accordance with claim 1, wherein the second speed mode has a continuous-shooting rate of frames set higher than in the first speed mode.

5. An imaging processing method for producing an image signal from signal charges obtained via photoelectric conversion from incident light from a subject field, and providing the image signals on multiple outputs driven depending on operational situation, said method comprising:
a first step of acquiring a preset condition;
a second step of determining whether the acquired set condition includes a first speed mode or a second speed mode that is faster than the first speed mode, and producing a control signal depending on a result of determination;
a third step of setting generation of a timing signal for providing the image signals in multiple outputs in response to the result of determination including the second speed mode;
a fourth step of setting generation of a normal timing signal for outputting the image signal on one channel in response to the result of determination including the first speed mode;
a fifth step of setting at least noise reduction and digitization on the image signals on a plurality of output channels supplied according to the result of determination including the second speed mode;
a sixth step of setting at least noise reduction and digitization on the image signal on one output channel supplied according to the result of determination including the first speed mode;
a seventh step of rearranging image data on the plurality of output channels digitized and supplied according to the result of determination including the second speed mode into a sequence of pixels in a normal dot-sequential manner; and
an eighth step of setting output of the image data on one output channel digitized and supplied according to the result of determination including the first speed mode,
whereby imaging is performed according to the settings to obtain the image data through the preprocessings.

6. The method in accordance with claim 5, wherein the second speed mode is of a higher resolution than in the first speed mode.

7. The method in accordance with claim 5, wherein the second speed mode is of a higher frame rate than in the first speed mode.

8. The method in accordance with claim 5, wherein the second speed mode has a continuous-shooting rate of frames higher than in the first speed mode.

9. An image pickup apparatus comprising:
an image sensor for receiving incident light from an subject field and producing signal charges corresponding to the incident light, said image sensor including a plurality of output circuits for converting the signal charges to an image signal to output the image signal, said image sensor being driven depending on situation of operation;
an operation panel for instructing the operation;
a controller operative in response to at least one of an operation signal from said operation panel and a predetermined condition for producing a control signal to control the operation of said image sensor;
a timing generator operative in response to the control signal for generating a timing signal for said image sensor;
a drive signal generator operative in response to the timing signal for generating a drive signal;
a preprocessor for applying at least noise reduction and digitization on the image signal on an output channel corresponding to effective one of said plurality of output circuits; and
a power controller operative in response to the control signal for controlling power supply, with respect to at least one of the output channels, to said preprocessor and said plurality of output circuits of said image sensor.

10. The apparatus in accordance with claim 9, wherein said power controller renders the power supply to one or ones of said plurality of output circuits other than said effective output circuit lower than the power supply to said effective output circuit.

11. The apparatus in accordance with claim 9, wherein said power controller controls connection and disconnection of the power supply.

12. The apparatus in accordance with claim 9, wherein said power controller adjusts voltage supplied from said drive signal generator to said plurality of output circuits of said image sensor to output a lower operational voltage in a single-output mode than in a multiple-output mode.

13. The apparatus in accordance with claim 9, further comprising a clock supply controller for controlling supply of a clock signal used in the processing of said preprocessor,
said power controller controlling the power supply to said plurality of output circuits of said image sensor.

14. The apparatus in accordance with claim 9, further comprising a checking circuit for comparing a residual capacity of a battery used with a predetermined threshold, and determining whether the residual capacity is equal to or more than the predetermined threshold,
said checker circuit being responsive to determination that the residual capacity is equal to or more than the predetermined threshold to drive said image sensor and said preprocessor in a multiple-output mode, said checker circuit being responsive to determination that the residual capacity is less than the predetermined threshold to drive said image sensor and said preprocessor in a single-output mode.

15. The apparatus in accordance with claim 9, further comprising a power supply circuit for detecting connection of an alternating-current-to-direct-current converter to the power supply,
said power supply circuit notifying said controller of the connection detected,
said controller controlling, in response to the connection notified, said image sensor and said preprocessor to the multiple-output mode.

16. An imaging processing method for producing an image signal from signal charges obtained via photoelectric conversion from incident light from a subject field, and providing the image signals on multiple outputs driven depending on operational situation, said method comprising:
a first step of acquiring a predetermined condition;
a second step of using the acquired predetermined condition and an operation signal to determine whether or not to provide multiple outputs for imaging, and generating a control signal depending on a result of determination;
a third step of setting generation of a timing signal to provide the image signal in multiple outputs in response to the result of determination of the multiple outputs;
a fourth step of rendering into an operative condition at least noise reduction and digitization processing on the image signals on a plurality of output channels supplied according to the result of determination of the multiple outputs;
a fifth step of rearranging image data on the plurality of output channels digitized and supplied according to the result of determination of the multiple outputs into a sequence of pixels in a normal dot-sequential manner;
a sixth step of setting normal generation of the timing signal to provide the image signal in the single output according to the result of determination of the single output;
a seventh step of rendering into the operative condition at least noise reduction and digitization processing on the image signal supplied on one output channel according to the result of determination of the single output mode; and
an eighth step of setting output of image data on the one output channel digitized and supplied according to the result of determination of the single output mode,
whereby imaging is performed according to the settings to obtain the image data through the preprocessings.

17. The method in accordance with claim 16, wherein said fourth and seventh steps render power supply effective under the operative condition.

18. The method in accordance with claim 16, wherein said fourth and seventh steps render a clock signal for operation effective under the operative condition.

19. The method in accordance with claim 16, further comprising:
a ninth step of setting supply of normal power-supply voltage in outputting the image signal according to the result of determination of the multiple outputs; and
a tenth step of setting supply of voltage lower than the normal power-supply voltage in outputting the image signal according to the result of determination of the single output.

20. The method in accordance with claim 11, wherein said tenth step sets the supply of voltage lower than the normal power-supply voltage to an output channel to be operated, and renders the power supplied to an output channel not to be operated lower than the power supplied to the output channel to be operated.

21. The method in accordance with claim 16, wherein said second step uses a residual capacity of a battery as a condition for determining whether or not imaging provides the multiple outputs, sets a capacity threshold of the battery, compares the capacity threshold with the residual capacity of the battery, determines whether or not the residual capacity of the battery is equal to or more than the capacity threshold, and produces a control signal depending on a result of determination.

22. The method in accordance with claim 21, further comprising a step of displaying a power-saving state for the result of determination in said second step that the residual capacity of the battery is less than the capacity threshold.

23. The method in accordance with claim 22, further comprising a step of displaying whether or not to set to the power-saving state for the result of determination in said second step that the residual capacity of the battery is less than the capacity threshold, allowing a user to determine whether or not the setting is possible to operate accordingly.

24. The method in accordance with claim 21, further comprising a step of detecting, before said second step, whether or not a converter for converting an alternating-current power supply to a direct-current power supply is connected as a power supply, and using a result of detection as the condition in said second step.

25. An image pickup apparatus comprising:
an image sensor for receiving incident light from an subject field and producing signal charges corresponding to the incident light, said image sensor including a plurality of output circuits for converting the signal charges to an image signal to output the image signal, said image sensor being driven depending on situation of operation;
an operation panel for instructing the operation to produce an operation signal;
a controller operative in response to the operation signal for producing a control signal to control a recording operation mode and a non-recording operation mode of said apparatus;
a timing generator operative in response to the control signal for generating a timing signal for said image sensor;
a drive signal generator operative in response to the timing signal for generating a drive signal;
a preprocessor for applying at least noise reduction and digitization on the image signal on an output channel corresponding to effective one of said plurality of output circuits; and
a processing controller operative in response to the control signal for controlling a processing for each of the output channels of said preprocessor,
said controller being operative in response to a set condition and a condition included in the operation signal to determine whether to be in the recording operation mode or the non-recording operation mode to produce the control signal according to a result of determination,
said processing controller controlling, in the recording operation mode, the processing at least on one output channel, and controlling, in the non-recording operation mode, the processing in a plurality of output channels.

26. The apparatus in accordance with claim 25, wherein the recording operation mode is a still image recording mode.

27. The apparatus in accordance with claim 25, wherein the recording operation mode is a motion picture recording mode.

28. The apparatus in accordance with claim 25, wherein the non-recording operation mode is a through-image mode in which a display displays an image captured during imaging.

29. The apparatus in accordance with claim 25, wherein the non-recording operation mode is a mode in which brightness of a subject in the subject field is measured.

30. The apparatus in accordance with claim 25, wherein the non-recording operation mode is a mode in which a distance to a subject in the subject field is measured.

31. An imaging processing method for generating an image signal from signal charges obtained via photoelectric conversion from incident light from an subject field, and providing the image signals on multiple outputs driven depending on operational situation, said method comprising:
a first step of acquiring an operation signal supplied depending on a predetermined condition and operation;
a second step of determining whether the acquired condition is a recording operation mode or a non-recording operation mode, and producing a control signal depending on a result of determination;
a third step of setting generation of a timing signal to provide the image signal in multiple outputs in response to the result of determination of the non-recording operation mode;
a fourth step of setting generation of a normal timing signal to provide the image signal on a single output channel according to the result of determination of the recording operation mode;
a fifth step of setting at least noise reduction and digitization on the image signal on a plurality of channels supplied according to the result of determination of the non-recording operation mode;
a sixth step of setting at least noise reduction and digitization on the image signal of one output channel supplied according to the result of determination of the recording operation mode;
a seventh step of rearranging image data on the plurality of output channels digitized and supplied according to the result of determination of the non-recording operation mode into a sequence of pixels in a normal dot-sequential manner; and
an eighth step of setting output of the image data on one output channel digitized and supplied according to the result of determination of the recording operation mode,
whereby imaging is performed according to the settings to obtain the image data through the preprocessings.

32. The method in accordance with claim 31, wherein the recording operation mode is a still image recording mode.

33. The method in accordance with claim 31, wherein the recording operation mode is a motion picture recording mode.

34. The method in accordance with claim 31, wherein the non-recording operation mode is a through-image mode in which a display displays an image captured during imaging.

35. The method in accordance with claim 31, wherein the non-recording operation mode is a mode in which brightness of a subject in the subject field is measured.

36. The method in accordance with claim 3, wherein the non-recording operation mode is a mode in which a distance to a subject in the subject field is measured.
